(19) United States
(12) Patent Application Publication
(10) Pub. No.: US 2009/0157565 A1
(43) Pub. Date: Jun. 18, 2009

(54) Method and System: [1] to Automatically Segregate Income that is (a) "Exempt From" from the Unrelated Business Income Tax, from Income that is (b) "Subject To" the Unrelated Business Income Tax; [2] to Create Leverage (without Debt Financing); and [3] to Control the Allocation of Investment Profits between Accounts and Investors; in order to Accelerate the Growth of Retirement Accounts and other Tax Exempt and/or Tax Deferred Entities and Accounts in compliance with the Unrelated Business Income Tax in 26 USC 511-514

(76) Inventor: William Breck, Sparks, NV (US)

Correspondence Address: IRA INVESTMENTS, LLC;(ATTN WM BRECK), 1285 BARING BLVD #205, SPARKS, NV, 89434, US

(21) Appl. No.: 11/955,356

(22) Filed: Dec. 12, 2007

(51) Int. Cl. G06Q 40/00

(52) U.S. Cl. 705/36 T

(57) ABSTRACT

Methods, structures and systems are disclosed which, in their separate parts and when used in combination:
[1] provide a mechanism to automatically segregate according to its “tax characteristics” (as determined for U.S. Federal Income Tax purposes) (a) that certain “income” derived from any particular “investment” or group of “investments” which is/are “subject to” the Unrelated Business Income Tax, away from (b) that certain “income” derived from the same or any other “investments” which is/are “exempt from” the Unrelated Business Income Tax, and thus provide a mechanism for “investments” to be made by “tax exempt” and “tax deferred” entities and accounts without a prior conclusive determination of whether any particular investment will generate “income” or “profits” that are “subject to”, or “exempt from”, the Unrelated Business Income Tax (i.e., the “UBIT”, imposed on “tax exempt” and “tax deferred” entities and accounts by 26 USC 511-514, IRC 511-514);
[2] permit the addition of an optional mechanism to facilitate the use of “leverage” without “debt financing” to substantially increase the Return on Investment (ROI) allocable to particular “investors” intended to be favored (the “favored investors”), without such “leverage” causing the “income” or “profits” realized (that would not otherwise be “subject to” the UBIT) to become “subject to” the UBIT on account of “debt financing” within the meaning of IRC 512(b)(4);
[3] permit the addition of an optional mechanism to facilitate the use of “debt financing” to leverage investment returns (which causes the “income” generated from the “debt financed” investment to become “subject to” the UBIT, under IRC 512(b)(4)-), with the mechanism described in ¶[1] above providing the mechanism to “automatically segregate” the “debt financed” “income” away from other “income” that is “exempt from” the UBIT;
[4] permit the addition of an optional mechanism to permit an investment manager to control the allocation of “future profits” to and among various “participating investors”, without violating the “prohibited transaction” rules in 26 USC 408 and 26 USC 4975;
   in order to increase the ability of “favored investors” (e.g., IRAs, other retirement plans and accounts, other “tax exempt” entities, and other “favored investors”), to accumulate substantial sums, without violating the “prohibited transaction rules” in 26 USC 408 and 26 USC 4975.

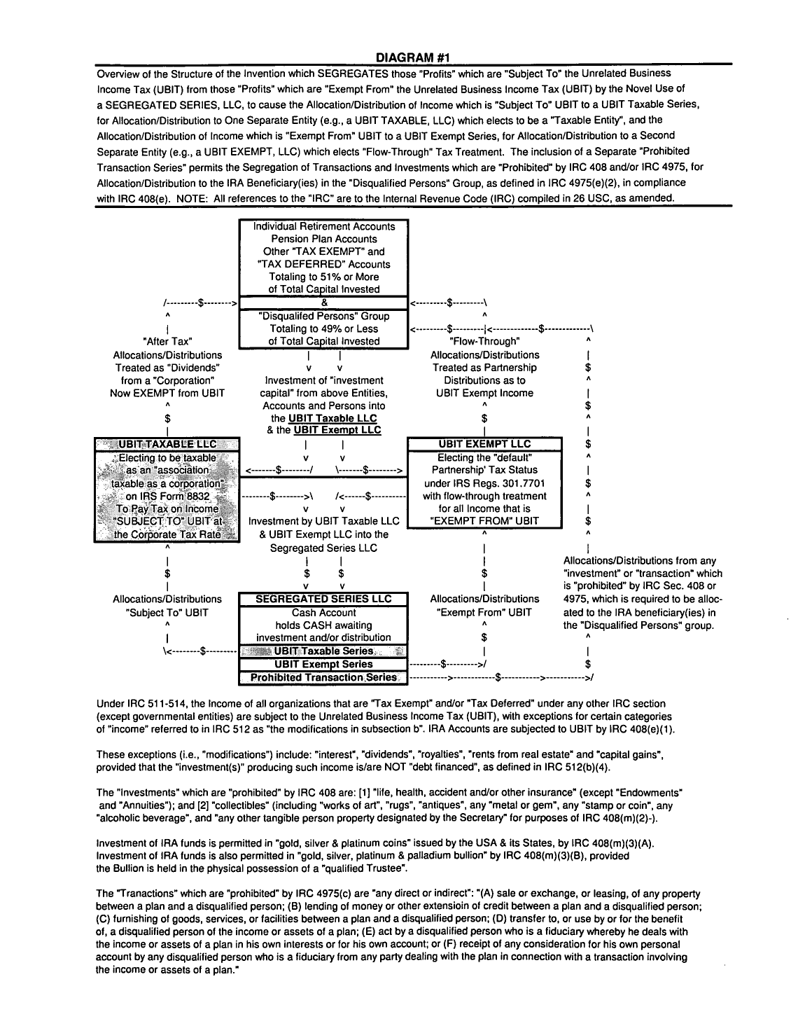

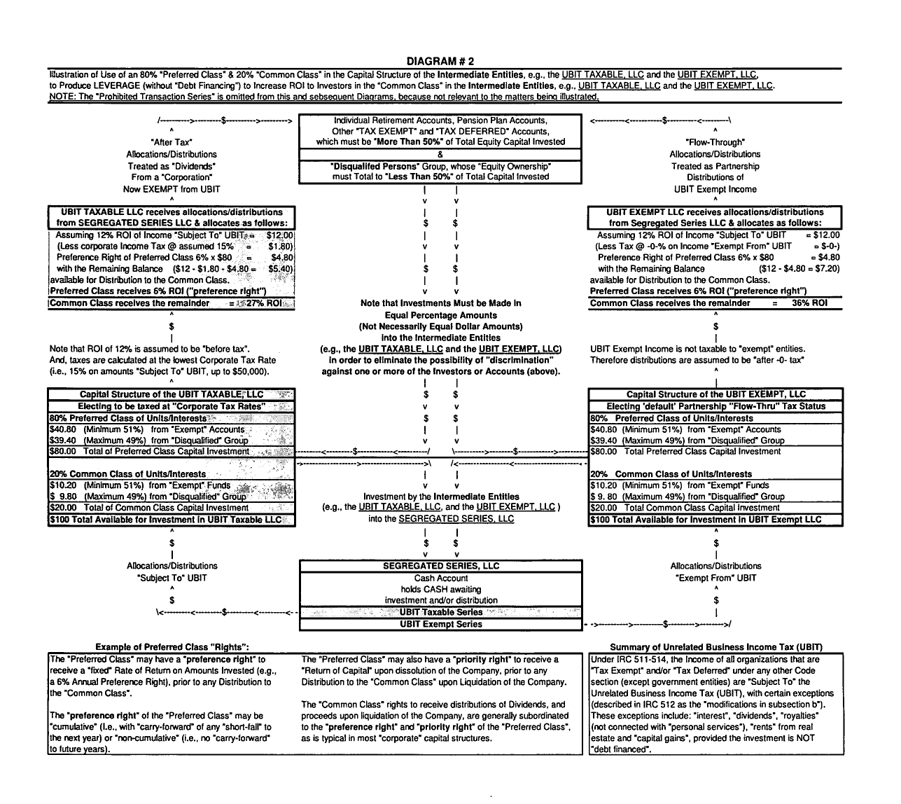

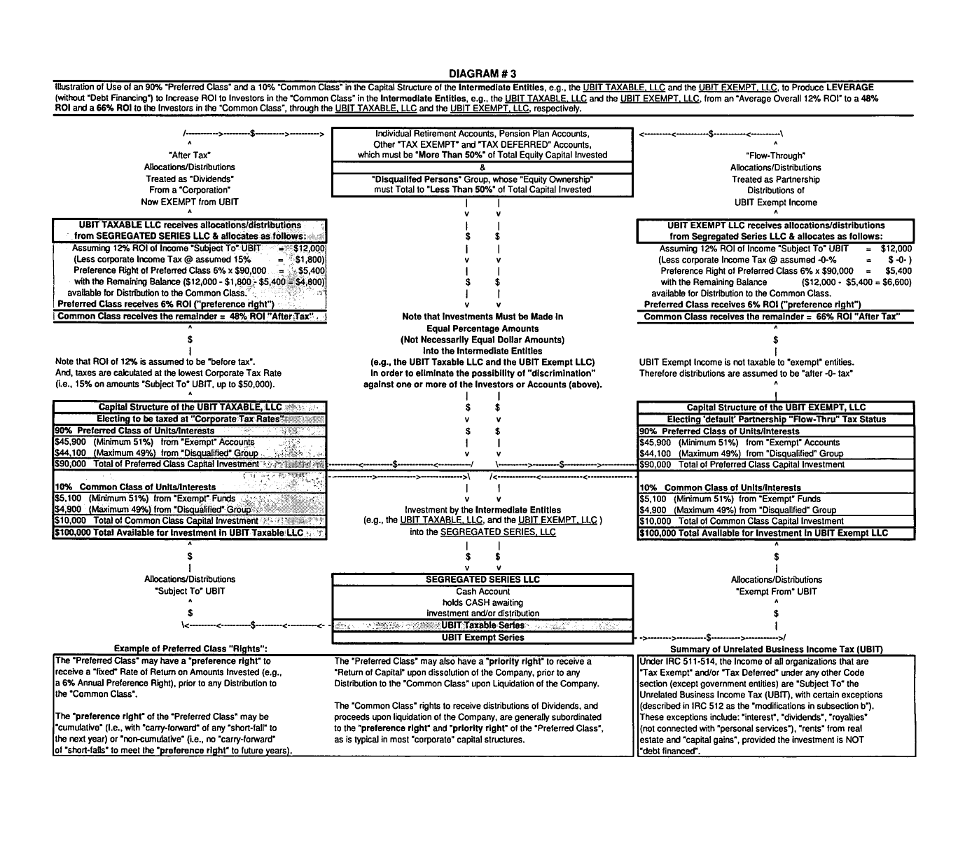

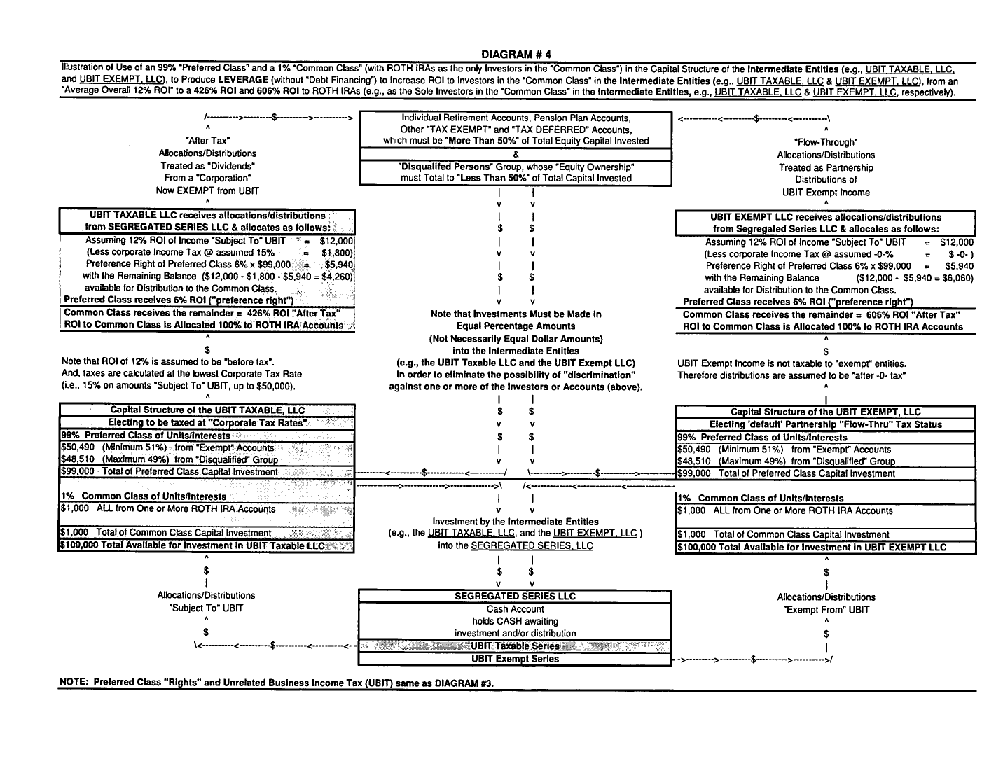

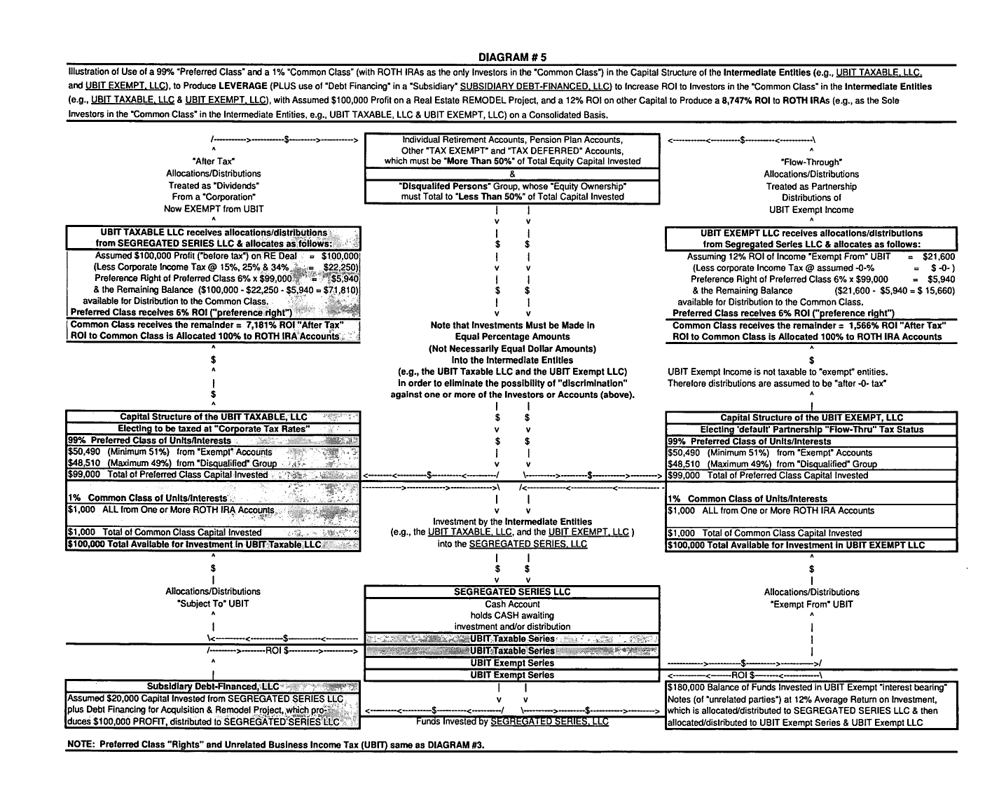

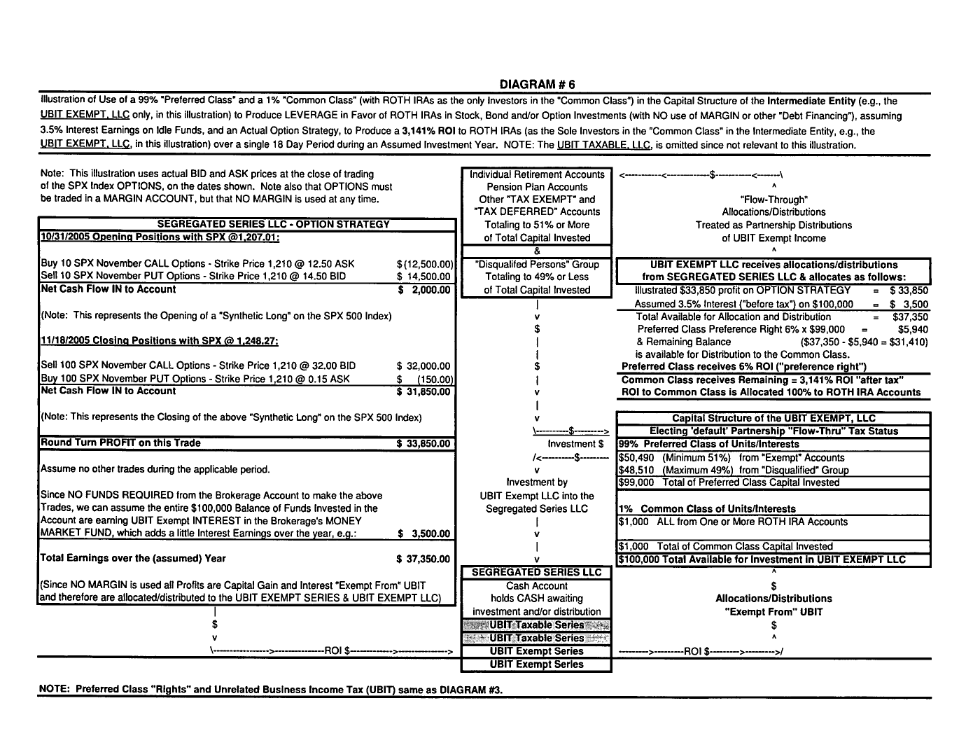

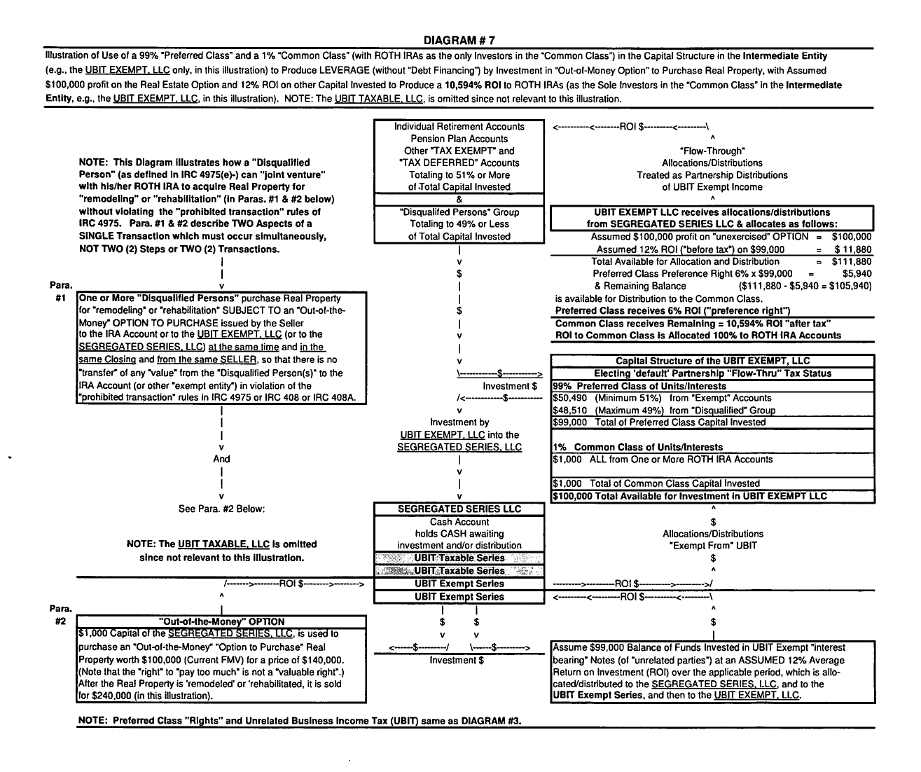

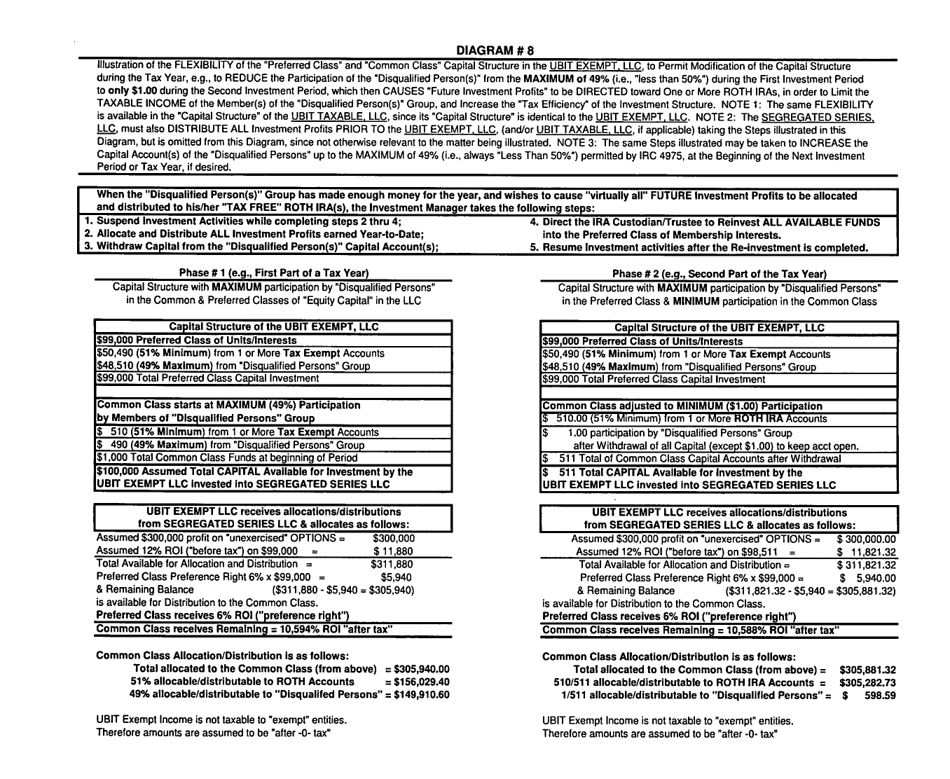

### CROSS-REFERENCE TO RELATED APPLICATIONS

Provisional Application

| | |
|---|---|
| EFS ID: | 1369741 |
| Application #: | 60869680 |
| Confirmation #: | 1635 |
| Filed: | 12-DEC-2006 |

### GOVERNMENT INTERESTS

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### REFERENCE TO COMPUTER PROGRAM LISTING COMPACT DISC APPENDIX

Not Applicable

### BACKGROUND OF THE INVENTION

1. Field of the Invention

The invention describes a structure and methodology for accelerating the growth of the funds in retirement accounts, such as Individual Retirement Accounts (“IRAs”), as well as other “tax exempt” and/or “tax deferred” entities and accounts, with particular emphasis on ROTH IRA Accounts, which may “accumulate” unlimited amounts of investment “income”, “gains” and “profits” on a “Tax Exempt” basis, and which may make “distributions” to the IRA Beneficiary in Retirement (i.e., after the IRA has been in existence for 5 years and the Beneficiary reaches age 59½) completely “Tax Free” to the IRA Beneficiary, by use of structures which “segregate” income that is “subject to” the Unrelated Business Income Tax (i.e., “UBIT Taxable”) from income that is “exempt” from the Unrelated Business Income Tax (i.e., “UBIT Exempt”), thus permitting persons who are not Income Tax Professionals to make investments without concern about the applicability of the Unrelated Business Income Tax (i.e., “UBIT”) to the particular investments made.

2. Description of the Prior Art

Traditional strategies for investing funds held in IRAs (and other “tax exempt” and “tax deferred” entities, funds and accounts) focus on a limited number of investments which generate income of a character that is not “subject to” (i.e., that is “exempt” from) the Unrelated Business Income Tax (UBIT), imposed by 26 USC §511-514 and the regulations thereunder, which UBIT applies to all “tax exempt” and “tax deferred” retirement plans, as well as other “tax exempt” entities, such as foundations, charitable trusts, etc. (except governmental agencies). Typical investments include “stocks” which generate “dividends” and hopefully “capital gains” over the holding period (both of which are “exempt” from the UBIT as long as not “debt financed”), and “bonds” which generate “interest” (which is also “exempt” from the UBIT as long as not “debt financed”). However, the limitation of the investments typically used is not the necessary consequence of any law or regulation, but the result of the practical consideration that non-traditional investments which might otherwise be undertaken (i.e., which are potentially subject to UBIT taxation) may cause the IRA to become subject to taxation at the higher tax rates applicable to Trusts, thus creating additional expense for filing Trust Tax Returns for the IRA, dealing with IRS Audits of the IRA Tax Returns, and sacrificing the principal advantage of IRAs which is their ability to receive investment income without current income taxation (except as to income that is “subject to” the UBIT). As a result, most IRAs (and other “tax exempt” and “tax deferred” entities, funds and accounts) are invested at relatively low yields, which prevent the accumulation of significant financial assets for retirement and other uses.

It is also generally understood that the principal accumulations of wealth in retirement plans occurs only in plans funded by the government and large employers, all of which funds are fully taxable to the plan Beneficiary when withdrawn in retirement. However, ROTH IRAs, which are not generally available to high income individuals and individuals who are participants in the typical retirement plans of governments and large employers, are not subject to income tax on sums withdrawn in retirement, and are therefore more desirable to grow at accelerated rates in order to increase the amount of funds available which will not be subject to income tax when withdrawn in retirement by the plan Beneficiary.

A handful of more “aggressive” Tax Professionals and Investment Advisors recommend investments in real estate and other investments that are permitted to IRAs and other “tax exempt” and “tax deferred” entities and accounts, but generally without an adequate structure in place that would permit the IRA Beneficiary (or other Investment Manager) to make the investment without concern about whether the investment will be “subject to” or “exempt from” the Unrelated Business Income Tax (UBIT), therefore requiring more involvement by the Tax Professional or Investment Advisor in the investment process, with the additional expense and delays concomitant with the greater involvement of the Tax Professional or Investment Advisor, which can be prohibitive to small IRA accounts.

The current state of knowledge about how to structure IRA investments for maximum accumulation of wealth is represented by the following reference materials, each of which is hereby incorporated by reference herein to the extent necessary to an understanding of the current state of the art in the field of the invention: Retire Rich With Your Self-Directed IRA: What your Broker & Banker Don't Want You to Know About Managing Your Own Retirement Investments, by Nora Peterson; All About Self-Directed IRA Investing, by Steve Merritt; Self Directed IRAs for the Active Investor: Taking Charge of Building Your Nest Egg, by Peter D. Heerwagen; New IRAs and How to Make Them Work for You, by Neil Downing; Roth to Riches: The Ordinary to Roth IRA Handbook, by John D. Bledsoe; Using IRAs and 401(k)s to Invest In Real Estate and Nontraditional Assets, by Jim Hitt; Self-Directed IRAs: Investment, Marketing and Trust Administration Strategies, by Jerome R. Corsi.

3. Legal Background

26 USC 401 permits “employers” (including some “self-employed” persons) to establish a variety of Pension and Retirement Plans, including “Profit Sharing Plans”, “Defined Contribution Plans”, “Defined Benefit Plans”, and “401K Plans”, which Plans are “tax deferred” under 26 USC 501, until the funds are “withdrawn” by the Plan “Beneficiary” in retirement (i.e., after age 59½). (Note that “withdrawals” which are “taxable” must be distinguished from “rollovers” and “account transfers” which are not counted as “taxable” to the Beneficiary.) Contributions to the Plan by the “employer” are deductible to the “employer” and not taxable to the “employee” who is the Plan Beneficiary, until “withdrawn” by the Beneficiary. A “penalty tax” of 10% applies, in addition to the ordinary Income Tax, to amounts withdrawn prior to age 59½ (with certain exceptions, such as “disability”, etc., which are not relevant here), which “penalty tax” is generally considered to be intended to encourage the Plan Beneficiaries to leave the funds in the Plan to accumulate until “retirement” (i.e., after age 59½). Withdrawals from the Plan are also required to begin no later than the year that the Plan Beneficiary reaches age 70½, in such amounts annually as are equal to or greater than the annual minimum “withdrawal” that would deplete the Beneficiary's Account over the remaining “life expectance” of the individual Beneficiary, determined under tables prescribed by the U.S. Internal Revenue Service.

26 USC 408 permits “individuals” to establish an Individual Retirement Account (a “Traditional” IRA) which can accumulate on a “tax deferred” basis until funds are withdrawn from the IRA in retirement, after age 59½. A deduction is “permitted” for contributions to the Traditional IRA, up to the amount of $4,000 per year, which amount is adjusted periodically by the Congress, which has recently permitted “catch-up” contributions in the amount of $500 per year ($1,000 per year for 2006 and after) for taxpayers over the age of 50. A 10% “penalty tax” applies to any “withdrawals” prior to age 59½ (with certain exceptions for “disability”, etc. which are not relevant here), and “withdrawals” are required to begin no later than age 70½, with the minimum withdrawal amount determined by the Beneficiary's “life expectance” as for the other Plans referenced above.

26 USC 408A permits “individuals” to establish a ROTH Individual Retirement Account (a “ROTH IRA”) to which “contributions” are limited in amount the same as for the Traditional IRA, but which “contributions” are not “tax deductible”. However, in contrast to the Traditional IRA (with “withdrawals” treated as “taxable income”), “withdrawals” from a ROTH IRA are “not taxable” to the “withdrawing” Beneficiary, provided the ROTH IRA has been in existence for at least 5 “tax years” and the Beneficiary is age 59½ or over at the time of the “withdrawal”. Also, in contrast to the Traditional IRA, a ROTH IRA may be established at any age, and the Beneficiary of a ROTH IRA is not required to begin taking “minimum” “distributions” or “withdrawals” at age 70½ or at any age, thus presenting the possibility that the ROTH IRA may be used to accumulate substantial wealth which will never become subject to the U.S. Income Tax.

However, if a ROTH IRA has substantial assets remaining in the ROTH IRA Account at the death of the Account Beneficiary, the surviving heirs who inherit the ROTH IRA (the survivor Beneficiary(ies)-) are required to begin “withdrawals” of a minimum amount each year that is projected to cause the “distribution” of the entire value of the ROTH IRA over the life expectancy of the survivor Beneficiary(ies), determined under tables prescribed by the U.S. Internal Revenue Service, in the same manner as for other Plans and IRAs. The only difference of significance, it that the “minimum distributions” and/or “withdrawals” from the ROTH IRA are not “subject to” the U.S. Income Tax when received by the survivor Beneficiary(ies), since they would not have been “subject to” the U.S. Income Tax when received by the IRA Beneficiary.

However, the ability of the ROTH IRA to be used to accumulate additional wealth by continuing its investments and making new investments continues during the period of required “minimum distributions” to the survivor Beneficiary(ies), so that the amount of wealth accumulation available for “tax free” “distribution” or “withdrawal” can continue for a very substantial period of time, which by some estimates may be as long as 100 years or more.

All Pension Plans and IRAs, however, must comply with the “prohibited transaction” rules of 26 USC 4975, which in general prohibit:
“any direct or indirect
(A) sale or exchange, or leasing, of any property between a plan and a disqualified person;
(B) lending of money or other extension of credit between a plan and a disqualified person;
(C) furnishing of goods, services, or facilities between a plan and a disqualified person;
(D) transfer to, or use by or for the benefit of, a disqualified person of the income or assets of a plan;
(E) act by a disqualified person who is a fiduciary whereby he deals with the income or assets of a plan in his own interests or for his own account; or
(F) receipt of any consideration for his own personal account by any disqualified person who is a fiduciary from any party dealing with the plan in connection with a transaction involving the income or assets of the plan.”—26 USC 4975(c)(1).

Note that any “borrowing” from an IRA Account or use of an IRA Account as “collateral” for a loan will also constitute a “prohibited transaction” by virtue of the prohibition in 26 USC 408(e)(3).

The group of “disqualified person(s)” referred to in the preceding paragraphs are defined in 26 USC 4975(e)(2)-(6) as follows:
“(2) Disqualified person. For purposes of this section, the term ‘disqualified person’ means a person who is
   (A) a fiduciary;
   (B) a person providing services to the plan;
   (C) an employer any of whose employees are covered by the plan;
   (D) an employee organization any of whose members are covered by the plan;
   (E) an owner, direct or indirect, of 50 percent or more of—(i) the combined voting power of all classes of stock entitled to vote or the total value of shares of all classes of stock of a corporation, (ii) the capital interest or the profits interest of a partner-ship, or (iii) the beneficial interest of a trust or unincorporated enterprise, which is an employer or an employee organization described in subparagraph (C) or (D);
   (F) a member of the family (as defined in paragraph (6)) of any individual described in subparagraph (A), (B), (C), or (E);
   (G) a corporation, partnership, or trust or estate of which (or in which) 50 percent or more of—(i) the combined voting power of all classes of stock entitled to vote or the total value of shares of all classes of stock of such corporation, (ii) the capital interest or profits interest of such partnership, or (iii) the beneficial interest of such trust or estate, is owned directly or indirectly, or held by persons described in subparagraph (A), (B), (C), (D), or (E);
   (H) an officer, director (or an individual having powers or responsibilities similar to those of officers or directors), a 10 percent or more shareholder, or a highly compensated employee (earning 10 percent or more of the yearly wages of an employer) of a person described in subparagraph (C), (D), (E), or (G); or
   (I) a 10 percent or more (in capital or profits) partner or joint venturer of a person described in subparagraph (C), (D), (E), or (G). The Secretary, after consultation and coordination with the Secretary of Labor or his delegate, may by regulation prescribe a percentage lower than 50 percent for subparagraphs (E) and (G) and lower than 10 percent for subparagraphs (H) and (I).
(3) Fiduciary. For purposes of this section, the term “fiduciary” means any person who
   (A) exercises any discretionary authority or discretionary control respecting management of such plan or exercises any authority or control respecting management or disposition of its assets,
   (B) renders investment advice for a fee or other compensation, direct or indirect, with respect to any moneys or other property of such plan, or has any authority or responsibility to do so, or
   (C) has any discretionary authority or discretionary responsibility in the administration of such plan. Such term includes any person designated under section 405(c)(1)(B) of the Employee Retirement Income Security Act of 1974.
(4) Stockholdings. For purposes of paragraphs (2)(E)(i) and (G)(i) there shall be taken into account indirect stockholdings which would be taken into account under section 267(c), except that, for purposes of this paragraph, section 267(c)(4) shall be treated as providing that the members of the family of an individual are the members within the meaning of paragraph (6).
(5) Partnerships; trusts. For purposes of paragraphs (2)(E)(ii) and (iii), (G)(ii) and (iii), and (I) the ownership of profits or beneficial interests shall be determined in accordance with the rules for constructive ownership of stock provided in section 267(c) (other than paragraph (3) thereof), except that section 267(c)(4) shall be treated as providing that the members of the family of an individual are the members within the meaning of paragraph (6).
(6) Member of family. For purposes of paragraph (2)(F), the family of any individual shall include his spouse, ancestor, lineal descendant, and any spouse of a lineal descendant.”—26 USC 4975(e)(2)-(6)

All IRAs and Pension Plans are also subject to the “Unrelated Business Income Tax” (UBIT) contained in 26 USC 511-514, by virtue of the provision in 26 USC 511(a)(2)(A) which applies to “Organizations described in sections 401(a) and 501(c)” (i.e., Pension Plans described in 26 USC 401(a) and 401K Plans which are described in 26 USC 401(k), and are “exempt” from income tax by virtue of 26 USC 501(a)-), and 26 USC 408(e) (which applies to Traditional IRA Accounts, and to ROTH IRA Accounts by virtue of the provision in 26 USC 408A(a)-) which states:
“(e) Tax treatment of accounts and annuities.
(1) Exemption from tax. Any individual retirement account is exempt from taxation under this subtitle unless such account has ceased to be an individual retirement account by reason of paragraph (2) or (3). Notwithstanding the preceding sentence, any such account is subject to the taxes imposed by section 511 (relating to imposition of tax on unrelated business income of charitable, etc. organizations).
(2) Loss of exemption of account where employee engages in prohibited transaction.
   (A) In general. If, during any taxable year of the individual for whose benefit any individual retirement account is established, that individual or his beneficiary engages in any transaction prohibited by section 4975 with respect to such account, such account ceases to be an individual retirement account as of the first day of such taxable year. For purposes of this paragraph
      (i) the individual for whose benefit any account was established is treated as the creator of such account, and
      (ii) the separate account for any individual within an individual retirement account maintained by an employer or association of employees is treated as a separate individual retirement account.
   (B) Account treated as distributing all its assets. In any case in which any account ceases to be an individual retirement account by reason of subparagraph (A) as of the first day of any taxable year, paragraph (1) of subsection (d) applies as if there were a distribution on such first day in an amount equal to the fair market value (on such first day) of all assets in the account (on such first day).”—26 USC 408(e)(2)-(3).

The “Unrelated Business Income Tax” is defined in 26 USC 512(a)(1) as follows:
“(1) Except as otherwise provided in this subsection, the term ‘unrelated business taxable income’ means the gross income derived by any organization from any unrelated trade or business (as defined in section 513) regularly carried on by it, less the deductions allowed by this chapter which are directly connected with the carrying on of such trade or business, both computed with the modifications provided in subsection (b).”—26 USC 512(a)(1).

The “modifications” provided in subsection (b) permit certain kinds of “income, gains and profits” to be received by the Account or Entity “exempt from” the “Unrelated Business Income Tax” (UBIT), including “interest”, “dividends”, “royalties” (which are not tainted by personal services connected with the generation of the ‘royalty’ income), “capital gains” and “rents from real property”, provided the investment is not “debt financed” (26 USC 512(b)(4)-).

The most important “modifications” which permit income, gains and profits to be received by IRAs and Pension Accounts are set forth in 26 USC 512(b), as follows:
“(b) Modifications. The modifications referred to in subsection (a) are the following:
(1) There shall be excluded all dividends, interest, payments with respect to securities loans (as defined in section 512(a)(5)), amounts received or accrued as consideration for entering into agreements to make loans, and annuities, and all deductions directly connected with such income.
(2) There shall be excluded all royalties (including overriding royalties) whether measured by production or by gross or taxable income from the property, and all deductions directly connected with such income.
(3) In the case of rents
   (A) Except as provided in subparagraph (B), there shall be excluded—(i) all rents from real property (including property described in section 1245(a)(3)(C)), and (ii) all rents from personal property (including for purposes of this paragraph as personal property any property described in section 1245(a)(3)(B)) leased with such real property, if the rents attributable to such personal property are an incidental amount of the total rents received or accrued under the lease, determined at the time the personal property is placed in service.
   (B) Subparagraph (A) shall not apply—(i) if more than 50 percent of the total rent received or accrued under the lease is attributable to personal property described in subparagraph (A)(ii), or (ii) if the determination of the amount of such rent depends in whole or in part on the income or profits derived by any person from the property leased (other than an amount based on a fixed percentage or percentages of receipts or sales).
   (C) There shall be excluded all deductions directly connected with rents excluded under subparagraph (A).
(4) Notwithstanding paragraph (1), (2), (3), or (5), in the case of debt-financed property (as defined in section 514) there shall be included, as an item of gross income derived from an unrelated trade or business, the amount ascertained under section 514(a)(1), and there shall be allowed, as a deduction, the amount ascertained under section 514(a)(2).
(5) There shall be excluded all gains or losses from the sale, exchange, or other disposition of property other than—(A) stock in trade or other property of a kind which would properly be includible in inventory if on hand at the close of the taxable year, or (B) property held primarily for sale to customers in the ordinary course of the trade or business. There shall also be excluded all gains or losses recognized, in connection with the organization's investment activities, from the lapse or termination of options to buy or sell securities (as defined in section 1236(c)) or real property and all gains or losses from the forfeiture of good-faith deposits (that are consistent with established business practice) for the purchase, sale, or lease of real property in connection with the organization's investment activities. This paragraph shall not apply with respect to the cutting of timber which is considered, on the application of section 631, as a sale or exchange of such timber.”—26 USC 512(b)(1)-(5).

Note that there are additional provisions of 26 USC 512, which are important to charitable trusts, educational and scientific organizations, which may also benefit from the use of the invention described in this Application, but which are not set forth in detail in this Application, since the Application of the invention in the case of IRAs and Pension Accounts illustrates all of the essential elements of the invention, and such IRAs and Pension Accounts are presently expected to be the most frequent users of the invention described herein.

The definition of “unrelated business” in 26 USC 513(b)(2), which is specifically applicable to IRAs and Pension Accounts (each of which is required to be held in a “trust” by a qualified “trustee” or “custodian”), is as follows:
“(b) Special rule for trusts. The term “unrelated trade or business” means, in the case of— ______
(2) a trust described in section 401(a), or section 501(c)(17), which is exempt from tax under section 501(a);
any trade or business regularly carried on by such trust or by a partnership of which it is a member.”—26 USC 513(b)(2).

Under 26 USC 514, “Unrelated debt financed income and deductions” are those which are derived from “debt financed property”, as defined in 514(b), as follows:
“(b) Definition of debt-financed property.
(1) In general. For purposes of this section, the term ‘debt-financed property’ means any property which is held to produce income and with respect to which there is an acquisition indebtedness (as defined in subsection (c)) at any time during the taxable year (or, if the property was disposed of during the taxable year, with respect to which there was an acquisition indebtedness at any time during the 12-month period ending with the date of such disposition), except that such term does not include
   (A)(i) any property substantially all the use of which is substantially related (aside from the need of the organization for income or funds) to the exercise or performance by such organization of its charitable, educational, or other purpose or function constituting the basis for its exemption under section 501 (or, in the case of an organization described in section 511 (a)(2)(B), to the exercise or performance of any purpose or function designated in section 501(c)(3)), or (ii) any property to which clause (i) does not apply, to the extent that its use is so substantially related;
   (B) except in the case of income excluded under section 512(b)(5), any property to the extent that the income from such property is taken into account in computing the gross income of any unrelated trade or business;
   (C) any property to the extent that the income from such property is excluded by reason of the provisions of paragraph (7), (8), or (9) of section 512(b) in computing the gross income of any unrelated trade or business; or (D) any property to the extent that it is used in any trade or business described in paragraph (1), (2), or (3) of section 513(a).”—26 USC 514(b)(1)

And the term “acquisition indebtedness” is defined in 26 USC 514(c) as follows:
“(c) Acquisition indebtedness.
(1) General rule For purposes of this section, the term ‘acquisition indebtedness’ means, with respect to any debt-financed property, the unpaid amount of
   (A) the indebtedness incurred by the organization in acquiring or improving such property;
   (B) the indebtedness incurred before the acquisition or improvement of such property if such indebtedness would not have been incurred but for such acquisition or improvement; and
   (C) the indebtedness incurred after the acquisition or improvement of such property if such indebtedness would not have been incurred but for such acquisition or improvement and the incurrence of such indebtedness was reasonably foreseeable at the time of such acquisition or improvement.
(2) Property acquired subject to mortgage, etc. For purposes of this subsection
   (A) General rule Where property (no matter how acquired) is acquired subject to a mortgage or other similar lien, the amount of the indebtedness secured by such mortgage or lien shall be considered as an indebtedness of the organization incurred in acquiring such property even though the organization did not assume or agree to pay such indebtedness. ______ ”—26 USC 514(c)(1) & (2)(A)

26 USC 511-514 also contains various exceptions and computational instructions which apply in particular cases and are not considered pertinent to the issues addressed in this application.

In summary, the Unrelated Business Income Tax (UBIT) applies to essentially all of the “income, gains and profits” derived by IRAs and Pension Accounts, and to significant parts of the “income, gains and profits” of “charitable”, “educational”, “scientific” and “religious” organizations and other “tax exempt” entities described in 26 USC 501(a), many of which organizations could benefit from the use of the structures comprising the invention described in this Application, in order to automatically “segregate” the income, gains and profits that are “subject to” the UBIT from the income, gains and profits that are “exempt from” the UBIT.

The provisions of the Internal Revenue Code relating to Pension Plans (including 26 USC 401) were enacted as part of the Employees Retirement Income Security Act (ERISA) in 1974, and have been amended a number of times since enactment. The provisions of 26 USC 408 (authorizing Traditional IRAs) was also enacted in 1974, and have been amended a number of times since enactment. The provisions of 26 USC 408A (authorizing ROTH IRAs) were enacted in 1997, and have been amended twice since enactment. The “prohibited transaction” rules in 26 USC 4975 were enacted in 1974, and have been amended a number of times since enactment. The “Unrelated Business Income Tax” (UBIT) in 26 USC 511-514 was reenacted as part of the re-codification of the 1954 Internal Revenue Code in 1954, and have been amended several times since re-enactment. All references to the provisions of the Internal Revenue Code (IRC), now compiled in Title 26 of the United States Code (USC), are to the provisions as in effect on the date of this Application.

4. Summary of Pertinent Cases and Rulings:

On Feb. 14, 1996, the United States Tax Court decided the very important case entitled “James H. Swanson and Josephine A. Swanson v. Commissioner of Internal Revenue” (the “Swanson” case), 106 T. C. 76 (Feb. 14, 1996). In the Swanson case, James Swanson was the President, CEO and sole shareholder of H & S Swanson Tool Co., Inc. (Swanson Tool) which manufactured parts for various equipment manufacturers. In January, 1985, James Swanson caused another corporation to be organized (i.e., Swanson Worldwide, Inc.), which elected to be taxed as a Domestic International Sales Corp. (DISC), to handle the “international sales” of Swanson Tool, and, as the sole officer and director of the DISC, arranged for 2500 shares of the DISC to be issued directly to his IRA account, at the “original issue” of the capital stock of the DISC. The IRA account thus became the “sole shareholder” of the DISC.

As stated in the opinion of the Tax Court: “For the taxable years 1985 to 1988, Swansons' Tool paid commissions to Worldwide [the DISC] with respect to the sale by Swansons' Tool of export property, as defined by section 993(c). In those same years, petitioner, who had been named president of Worldwide, directed, with Florida National's [i.e., the IRA's Trustee's] consent, that Worldwide pay dividends to IRA #1 [FN#3: totaling to “$593,602”] [, the] commissions paid to Worldwide received preferential treatment [FN#4: “Under sec. 991, except for the taxes imposed by Ch. 5, a DISC is not subject to income tax.”], and the dividends paid to IRA #1 were tax deferred pursuant to section 408. Thus, the net effect of these transactions was to defer recognition of dividend income that otherwise would have flowed through to any shareholders of the DISC.

“In 1988, IRA #1 was transferred from Florida National Bank to First Florida Bank, N. A. (hereinafter First Florida), as custodian. Swansons' Tool stopped paying commissions to Worldwide after Dec. 31, 1988, as petitioners no longer considered such payments to be advantageous from a tax planning perspective.

“In January 1989, petitioner directed First Florida to transfer $5,000 from IRA #1 to a new individual retirement custodial account (hereinafter IRA #2). Under the terms of the IRA agreement, First Florida was named custodian of IRA #2, and petitioner was named as the grantor for whose benefit the IRA was established. Under the terms of the IRA agreement, petitioner reserved the right to serve as the ‘Investment Manager’ of IRA #2.

“Contemporaneously with the formation of IRA #2, petitioner incorporated H & $ Swansons' Trading Company (hereinafter Swansons' Trading or the FSC). Petitioner directed First Florida to execute a subscription agreement for 2,500 newly issued shares of Swansons' Trading stock. The shares were subsequently issued to IRA #2, which became the corporation's sole shareholder. Swansons' Trading filed a Form 8879, Election To Be Treated as a FSC or as a Small FSC, on Mar. 31, 1989, and paid a dividend to IRA #2 in the amount of $28,000 during the taxable year 1990.”—Swanson Opinion at paras 11-14.

The IRS challenged these transactions on two bases, described in the Swanson Opinion as follows:

“As demonstrated by the revenue agent's report, respondent identified, as alternative positions, two ‘prohibited transactions’ which resulted in the loss of IRA #1's status as a trust under section 408. First, respondent concluded that:

“‘Mr. Swanson is a disqualified person within the meaning of section 4975(e)(2)(A) of the Code as a fiduciary because he has the express authority to control the investments of ______ [IRA#1].

“ ‘Mr. Swanson is also an Officer and Director of Swansons' Worldwide. Therefore, direct or indirect transactions described by section 4975(c)(1) between Swansons' Worldwide and ______ [IRA #1] constitute prohibited transactions.

“‘Mr. Swanson, as an Officer and Director of Worldwide directed the payment of dividends from Worldwide to ______ [IRA #1] ______ THE PAYMENT OF DIVIDENDS IS A PROHIBITED TRANSACTION WITHIN THE MEANING OF SECTION 4975(c)(1)(E) OF THE CODE AS AN ACT OF SELF-DEALING WHERE A DISQUALIFIED PERSON WHO IS A FIDUCIARY DEALS WITH THE ASSETS OF THE PLAN IN HIS OWN INTEREST. The dividend paid to ______ [IRA #1] Dec. 30, 1988, will cause the IRA to cease to be an IRA Effective Jan. 1, 1988 by reason of section 408(e)(1). Therefore, by operation of section 408(d)(1), the fair market value of the IRA is deemed distributed Jan. 1, 1988. [Emphasis added.]’ [Capitalization as in the original Opinion by the Court.]

“As further demonstrated by the revenue agent's report, respondent's second basis for disqualifying IRA #1 under section 408 was that:

“‘In his capacity as fiduciary of ______ [IRA#1], Mr. Swanson directed the bank custodian, Florid National Bank, to purchase all of the stock of Swansons' Worldwide. At the time of the purchase, Mr. Swanson was the sole director of Swansons' Worldwide.

“‘THE SALE OF STOCK BY SWANSONS’ WORLDWIDE TO MR. SWANSON'S INDIVIDUAL RETIREMENT ACCOUNT CONSTITUTES A PROHIBITED TRANSACTION WITHIN THE MEANING OF SECTION 4975(c)(1)(A) OF THE CODE. The sale occurred Feb. 15, 1985. By operation of section 408(e)(2)A) of the Code, the Individual Retirement Account terminated effective Jan. 1, 1985. [Capitalization as in the original Opinion by the Court.]

“‘Effective Jan. 1, 1985 the Individual Retirement Account is not exempt from tax under section 408(e)(1) of the Code. The fair market value of the account, including the 2500 shares of Swansons' Worldwide, is deemed to have been distributed to Mr. Swanson in accordance with section 408(e)(2)(B) of the Code. Therefore, Mr. Swanson effectively became the sole shareholder of Swansons' Worldwide, Inc. with the loss of the IRA's tax exemption. [Emphasis added.]’ [As in the original Opinion by the Court.]

“Although the record is not entirely clear on the matter, it appears that respondent imputed to IRA #2 the prohibited transactions found with respect to IRA #1 and used similar reasoning to disqualify IRA #2 as a valid trust under section 408(a).”—Swanson Opinion at paras. 21-23.

The Court summarized Mr. Swanson's position on the “prohibited transaction” issues, as follows:

“In their petition, filed Sep. 21, 1992, petitioners stated with respect to respondent's determination of ‘prohibited transactions’ that: (1) At all pertinent times IRA #1 was the sole shareholder of Worldwide; (2) since the 2,500 shares of Worldwide issued to IRA #1 were original issue, no sale or exchange of the stock occurred; (3) from and after the dates of his appointment as director and president of Worldwide, Mr. Swanson engaged in no activities on behalf of Worldwide which benefited him other than as a beneficiary of IRA #1; (4) IRA #1 was not maintained, sponsored, or contributed to by Worldwide during the years at issue; (5) at no time did Worldwide have any active employees; and (6) Mr. Swanson engaged in no activities on behalf of Swansons' Trading which benefited him other than as a beneficiary of IRA #2.”—Swanson Opinion at para. 25.

The Court then examined the question of whether the position of the IRS taken in this case (as summarized by the Court in the quotations above) was “substantially justified”, as follows:

“Petitioners contend that respondent was not substantially justified in maintaining throughout the proceedings that prohibited transactions had occurred with respect to IRA #1, and by implication, IRA #2. We agree.

“As stated previously, respondent based her determination of prohibited transactions on section 4975(c)(1)(A) and (E). Section 4975(c)(1)(A) defines a prohibited transaction as including any ‘sale or exchange, leasing, of any property between a plan [FN #11: “A ‘plan’ is defined by sec. 4975(e)(1) to encompass an individual retirement account as described under sec. 408.”] and a disqualified person who is a ‘fiduciary’. [FN #12: quotes sec. 4975(e)(2), which defines a “disqualified person”.] Section 4975(c)(1)E) further defines a prohibited transaction as including any ‘act by a disqualified person who is a fiduciary [FN #13: quotes sec. 4975(e)(3), which defines a “fiduciary”.] whereby he deals with the income or assets of a plan in his own interest or for his own account’.

“We find that it was unreasonable for respondent to maintain that a prohibited transaction occurred when Worldwide's stock was acquired by IRA #1. The stock acquired in that transaction was newly issued—prior to that point in time, Worldwide had no shares or shareholders. A corporation without shares or shareholders does not fit within the definition of a disqualified person under section 4975(e)(2)(G). [FN #14—quoted below at

It was only AFTER Worldwide issued its stock to IRA #1 that petitioner held a beneficial interest in Worldwide's stock, thereby causing Worldwide to become a disqualified person under section 4975(e)(2)(G). [FN #15—quoted below at [0060].] Accordingly, the issuance of stock to IRA #1 did not, within the plain meaning of section 4975(c)(1)(A), qualify as a ‘sale or exchange, or leasing, of any property between a plan and a DISQUALIFIED PERSON’. [FN #16—quoted below at [0061].] Therefore, respondent's litigation position with respect to this issue was unreasonable as a matter of both law and fact. [Capitalization as in the original Opinion by the Court.]

“We also find that respondent was not substantially justified in maintaining that the payments of dividends by Worldwide to IRA #1 qualified as prohibited transactions under section 4975(c)(1)(E). There is no support in that section for respondent's contention that such payments constituted acts of self-dealing, whereby petitioner, a ‘fiduciary’, was dealing with the assets of IRA #1 in his own interest. Section 4975(c)(1)(E) addresses itself only to acts of disqualified persons who, as fiduciaries, deal directly or indirectly with the INCOME OR ASSETS OF A PLAN for their own benefit or account. Here, there was no such direct or indirect dealing with the income or assets of a plan, as the dividends paid by Worldwide did not become INCOME OF IRA #1 until unqualifiedly made subject to the demand of IRA #1. Sec. 1.301-1(b), Income Tax Regs. Furthermore, respondent has never suggested that petitioner, acting as a ‘fiduciary’ or otherwise, ever dealt with the corpus of IRA #1 for his own benefit. [Capitalization as in the original Opinion by the Court.]

“Based on the record, the only direct or indirect benefit that petitioner realized from the payments of dividends by Worldwide related solely to his status as a participant of IRA #1. In this regard, petitioner benefited only insofar as IRA #1 accumulated assets for future distribution. Section 4975(d)(9) states that section 4975(c) shall not apply to:

“‘receipt by a disqualified person of any benefit to which he may be entitled as a participant or beneficiary in the plan, so long as the benefit is computed and paid on a basis which is consistent with the terms of the plan as applied to all other participants and beneficiaries.’

“Thus, we find that under the plain meaning [FN #17: id.] of section 4975(c)(1)(E), respondent was not substantially justified in maintaining that the payments of dividends to IRA #1 constituted prohibited transactions. Respondent's litigation position with respect to this issue was unreasonable as a matter of both law and fact. [FN #18:—quoted below at [0062].]”—Swanson Opinion at paras. 44-48.

“ . . . Accordingly, we find that respondent's litigation position with respect to IRA #1 was not substantially justified. Petitioners are therefore entitled to an award of litigation costs under section 7430.

“As respondent's determination of deficiencies with respect to IRA #2 was inexorably linked to the fate of IRA #1, the award of litigation costs is also intended to cover respondent's litigation position with respect to IRA #2. [FN #19—omitted.]”—Swanson Opinion at paras. 50-51.

FN #14: “Furthermore, we find that at the time of the stock issuance, Worldwide was not, within the meaning of 4975(e)(2)(C), an ‘employer’, any of whose employees were beneficiaries of IRA #1. Although 4975 does not define the term ‘employer’, we find guidance in sec. 3(5) of the Employee Retirement Income Security Act of 1974 (ERISA), Pub. L. 93-406, 88 Stat. 829, 834. In pertinent part, ERISA sec. 3(5) provides that, for plans such as an IRA, an ‘“employer” means any person acting directly as an employer, or indirectly in the interest of an employer, in relation to an employee benefit plan ______.’ Because Worldwide did not maintain, sponsor, or directly contribute to IRA #1, we find that Worldwide was not acting as an ‘employer’ in relation to an employee plan, and was not, therefore a disqualified person under sec. 4975(e)(2)(C). As there is no evidence that Worldwide was an ‘employee organization’, any of whose members were participants in IRA #1, we also find that Worldwide was not a disqualified person under sec. 4975(e)(2)(D).”—Swanson Opinion at Footnote 14.

FN #15: “Sec. 4975(e)(4) incorporates the constructive ownership rule of 267(c)(1), which states that:
“‘Stock owned, directly or indirectly, by or for a corporation, partnership, estate, or trust shall be considered as being owned proportionally by or for its shareholders, partners, or beneficiaries ______
“‘Petitioner, as the sole individual for whose benefit IRA #1 was established, was therefore beneficial owner of all the outstanding shares of Worldwide after they were issued. Because petitioner, as the sole beneficial shareholder of Worldwide, was also a ‘fiduciary’ with respect to IRA #1, Worldwide thus met the definition of a disqualified person under sec. 4975(e)(2)(G).’
“Contrary to respondent's representations, petitioner was not a ‘disqualified person’ as president and director of Worldwide until AFTER the stock was issued to IRA #1. Sec. 4975(e)(2)(H). Furthermore, petitioner was not a disqualified person under sec. 4975(e)(2)(H) solely due to his ‘shareholding’ in Worldwide as the constructive attribution rules provided under sec. 267 are applicable only to sec. 4975(e)(2)(E)(i) and (G)(i). Sec. 4975(e)(4).”—Swanson Opinion at Footnote 15.

FN #16: “Ordinarily, controlling effect will be given to the plain language of a statute unless to do so would produce absurd or futile results. Rath v. Commissioner, 101 T. C. 196, 200 (1993) (citing United States v. American Trucking Associations, 310 U.S. 534, 543-544 (1940)). As the Supreme court has stated:
“‘in the absence of clearly expressed legislative intention to the contrary, the language of the statute itself must ordinarily be regarded as conclusive. Unless exceptional circumstances dictate otherwise, when we find the terms of a statute unambiguous, judicial inquiry is complete. [Burlington No. R. v. Oklahoma Tax Comm., 481 U.S. 454, 461 (1987);

citations and internal quotation marks omitted.]
“Accordingly, when, as here, a statute is clear on its face, we require unequivocal evidence of a contrary purpose before construing it in a manner that overrides the plain meaning of the statutory words. Rath v. Commissioner, supra at 200-201 (citing Halpern v. Commissioner, 96 T. C. 895, 899 (1991); Huntsberry v. Commissioner, 83 T. C. 742, 747-748 (1984)).”—Swanson Opinion at Footnote 16.

FN #18: “______ In finding that respondent was not substantially justified with respect to the DISC issue, we have considered all grounds upon which respondent could fairly raise a question of prohibited transactions under sec. 4975.”—Swanson Opinion at Footnote 18.

The subsequent position of the Internal Revenue Service on the issues raised by the Swanson case is illustrated by the INTERNAL REVENUE SERVICE NATIONAL OFFICE FIELD SERVICE ADVICE (FSA 200128011) dated Apr. 6, 2001, from the OFFICE OF CHIEF COUNSEL to all ASSOCIATE AREA COUNSEL, the pertinent parts of which are quoted below:

“Issues

“1. Whether the Service should challenge the income tax results in this case, in which a domestic subchapter S corporation (US Corp) made export sales through a foreign sales corporation (FSC A) owned in equal shares by four individual retirement accounts (IRAs) established for the benefit of the four individual shareholders of US Corp (the majority owner and his three minor children). [Issue #2 addresses a “gift tax” issue which is not relevant here, and is therefore omitted.]

“Conclusions
“1. Based upon the facts given, we do not recommend challenging the income tax results in this case.

“Facts
“US Corp is a domestic subchapter S corporation. Father owns a majority (a %) of the shares of US Corp. Father's three minor children (individually “Child”, collectively “Children”) own the remaining shares of US Corp equally (each Child owns b % of the shares. Children own collectively c % of the shares). US Corp is in the business of selling Product A and some of its sales are made for export.

“Father and each Child own separate IRAs, to which each of them made an initial contribution of $d. Each of the four IRAs acquired a 25% interest in FSC A, a foreign sales corporation (‘FSC’) pursuant to section s 992(a)(1) and 927(b)(1) of the Code, by entering into a subscription agreement for newly issued shares, after FSC was formed in Month a of Year 1.

“US Corp entered into service and commissions agreements with FSC A (‘Agreements’) in Month A of Year 1. FSC A agreed to act as commission agent in connection with export sales made by US Corp, in exchange for commissions based upon the administrative pricing rules applicable to FSCs. US Corp also agreed to perform certain services on behalf of FSC A, such as soliciting and negotiating contracts, for which FSC A would reimburse US Corp its actual costs.

“During Taxable Year 1, FSC A made a total cash distribution of $e to its IRA shareholders, out of earnings and profits derived from foreign trade income relating to US Corp exports. The IRAs owning FSC A each received an equal amount of $f. Combined with previous distributions out of such earnings and profits by FSC A to the IRAs, and with the earnings by the IRAs on such distributions, the value of each IRA on Date 1 was more than $g.

“Law and Analysis
______
“There is no specific Code Provision or regulation prohibiting an IRA from owning the stock of a FSC. The type of investment that may be held in an IRA is limited only with respect to insurance contracts, under section 408(a)(3), and with respect to certain collectibles, under section 408(m)(1).

“Exemption from tax, under 408(e)(1), is the principal tax treatment of an IRA.

Notwithstanding this exemption, section 408(e)(1) provides that IRAs are taxable, under section 511, on any unrelated business income. Also, section 408(e)(2) provides that this section 408(e)(1) exemption is lost if an individual for whose benefit an IRA is established, or his beneficiary, engages in any transaction prohibited by 4975 (prohibited transaction) with respect to such IRA.

“In this case, the tax imposed by section 511 on unrelated business income does not apply to the dividends received by the IRAs from FSC A because section 512(b)(1) generally excludes dividends from the definition of unrelated business taxable income for purposes of section 511. [Footnote #2 omitted]

“We also consider whether there were prohibited transactions in this case. The issue of prohibited transactions, in circumstances similar to those in this case, was addressed in Swanson v. Commissioner, 106 T. C. 76 (1996). In that case, after initially alleging that prohibited transactions had occurred, the Service ultimately conceded the case. The U.S. Tax Court, in awarding litigation costs to the taxpayers under section 7430, held that the Service's position regarding prohibited transactions was not substantially justified.

“In the Swanson case, Mr. Swanson, the sole shareholder of a subchapter S corporation, H & S Swansons' Tool Co. (Tool Co.) arranged in January 1985 for the organization of a DISC, Swansons' Worldwide, Inc. (Worldwide DISC), as well as for the formation of a self-directed IRA (IRA #1) for his benefit. Mr. Swanson was named director and president of Worldwide DISC. On the same day that IRA #1 was created, Mr. Swanson directed the IRA #1 trustee to execute a subscription agreement for 2,500 shares of Worldwide DISC's original issue stock. The shares were subsequently issued to IRA #1, which become the sole shareholder of Worldwide DISC.

“For years 1985 to 1988, Tool Co. paid commissions to Worldwide DISC with respect to the sale by Tool Co. of export property. In the same years, Mr. Swanson, as president of Worldwide DISC, directed Worldwide DISC to pay dividends to IRA #1. The dividends totaled $593,602 for the four years. Tool Co. stopped paying commissions to Worldwide DISC after Dec. 31, 1988, as Mr. Swanson ‘no longer considered such payments to be advantageous from a tax planning perspective.’ Id. at 79 [Footnote #3 omitted]

“In 1989, Mr. Swanson directed the trustee of his IRA to transfer $5,000 to a new self-directed IRA (IRA #2) that he created for his own benefit and, at the same time, created a FSC, H & S Swansons' Trading Co. (Trading FSC). Mr. Swanson directed the trustee of IRA #2 to execute a subscription agreement for 2,500 newly issued shares of Trading FSC.

The shares were subsequently issued to IRA #2, which became the sole shareholder of Trading FSC. A dividend of $28,000 was paid by Trading FSC to IRA #2 in 1990.

“The Service issued notices of deficiency to Mr. Swanson and his wife alleging that prohibited transactions had occurred with respect to each IRA and that each IRA ceased to be an individual retirement account pursuant to 408 because of those transactions. The alleged prohibited transactions were (1) the sale of stock by Worldwide DISC and Trading FSC to the respective IRAs and (2) the payment of dividends by these companies to their IRA shareholders.

” ‘Prohibited transactions,’ include, inter alia, any ‘sale or exchange or leasing, of any property between a plan and a disqualified person’ (section 4975(c)(1)(A)); any ‘transfer to, or use by or for the benefit of, a disqualified person of the income or assets of a plan’ (section 4975(c)(1)(D)); and any ‘act by a disqualified person who is a fiduciary whereby he deals with the income or assets of a plan in his own interest or for his own account’ (section 4975(c)(1)(E)).

“Section 4975(e)(2) defines ‘disqualified person’ to include a fiduciary, an employer any of whose employees are covered by the plan, an owner of an employer, and certain officers and directors of an employer. Section 4975(e)(3) defines ‘fiduciary’ to include any person who exercises discretionary control over the management of the plan assets. Section 4975(e)(1) defines ‘plan’ to include IRAs. The court in Swanson concluded that, when the initial issuance of DISC (or FSC) [Footnote #4 omitted] stock to the IRA was made, the issuing company was not a ‘disqualified person’ because the newly issued stock was not owned by anyone at the time of the sale. Thus, the sale of stock to the IRA was not a sale or exchange of property between a plan (the IRA) and a disqualified person within the meaning of section 4975(c)(1)(A).

“The payment of dividends by a DISC (or FSC) to an IRA was held not to be the use of IRA assets for the benefit of a disqualified person within the meaning of section 4975(c)(1)(D) because the dividends did not become IRA assets until they were paid.

“The court also ruled that the actions of arranging for IRA ownership of DISC (or FSC) stock and for the subsequent payment of dividends by the DISC (or FSC) to the IRA, considered together, did not constitute an act whereby a fiduciary directly or indirectly ‘deals with the income or assets of a plan in his own interest or for his own account,’ within the meaning of section 4975(c)(1)E). The court noted that the Commissioner had not alleged that the taxpayer had ever dealt with the corpus of the IRA for his own benefit, stating:

“‘Based on the record, the only direct or indirect benefit that petitioner [Mr. Swanson] realized from the payments of dividends by [Worldwide FSC] related solely to his status as a participant of IRA #1. In this regard, petitioner benefited only insofar as IRA #1 accumulated assets for future distribution. Section 4975(d)(9) states that section 4975(c) shall not apply to:

“‘receipt by a disqualified person of any benefit to which he may be entitled as a participant or beneficiary in the plan, so long as the benefit is computed and paid on a basis which is consistent with the terms of the plan as applied to all other participants and beneficiaries.

“‘Thus, we find that under the plain meaning of section 4975(c)(1)(E), respondent was not substantially justified in maintaining that the payments of dividends to IRA #1 constituted prohibited transactions.—106 T. C. at 89-90.

“In light of Swanson, we conclude that a prohibited transaction did not occur under section 4975(c)(1)(A) in the original issuance of the stock of FSC A to the IRAs in this case. Similarly, we conclude that payments of dividends by FSC A to the IRAs in this case is not a prohibited transaction under section 4975(c)(1)(D). We further conclude, considering Swanson, that we should not maintain that the ownership of FSC A stock by the IRAs, together with the payment of dividends by FSC A to the IRAs, constitutes a prohibited transaction under section 4975(c)(1)(E).

“Accordingly, this case should not be pursued as one involving prohibited transactions. We note, however, that similar transactions may be prohibited under section 4975, based upon the particular facts of such transactions. For example, while FSC A in this case is not a disqualified person, the owners of the IRAs are disqualified persons as fiduciaries with respect [to] their IRAs and US Corp is a disqualified person with respect to the IRA owned by Individual A, the majority shareholder of US Corp. Thus, if a transaction is made for the purpose of benefiting US Corp, the IRA owners would violate section 4795(c)(1)(D) [sic. Probably should be 4975(c)(1)(D).] Also, if the facts were such that the IRA owners' interests in the transaction because of their ownership of US Corp affected their best judgments as fiduciaries of the IRAs, the transaction would violate section 4975(c)(1)(E).”—INTERNAL REVENUE SERVICE NATIONAL OFFICE FIELD SERVICE ADVICE (FSA 200128011) dated Apr. 6, 2001, from the OFFICE OF CHIEF COUNSEL to all ASSOCIATE AREA COUNSEL.

The Internal Revenue Service has also ruled, in PWBA 2000 10A, issued by the Chief of the Division of Fiduciary Interpretations Office of Regulations and Interpretations (the Adler case), that the investment of IRA funds into a partnership was not a prohibited transaction, where:
1. The ownership interest in the partnership by all members of the group of ‘disqualified persons’ (as defined in 4975(e)(2) in relation to the IRA(s) making the investment) totaled to less than 50% of the total ownership of the partnership;
2. The investment by the IRA in the partnership is not necessary in order for the partnership to qualify for any benefit, such as minimum account size for professional management services;
3. The IRA Beneficiary will not receive any compensation from the partnership;
4. The IRA Beneficiary will not receive any compensation on account of the acquisition by the IRA of its interest in the partnership;
5. The IRA funds will not be used to purchase any interest from any other partner.

The PWBA (Adler) memo states in pertinent part:

“Section 4975(c)(1)(A) of the Code prohibits any direct or indirect sale or exchange or leasing, of any property between a plan and a disqualified person. Section 4975(c)(1)(D) of the Code prohibits any direct or indirect transfer to, or use by or for the benefit of, a disqualified person of the income or assets of a plan. Section 4975(c)(1)(E) of the Code prohibits a fiduciary from dealing with the income or assets of a plan in his or her own interest or for his or her own account. ______

“As trustee with investment discretion over the assets of his IRA, Mr. Adler is a fiduciary, and therefore, a disqualified person under section 4975(e)(2) of the Code.

“Mr. Adler is also a disqualified person in his capacity as the general partner of the Partnership to the extent he exercises discretionary authority over the administration or management of the IRA assets invested in the Partnership. In addition, although Mr. Adler, his son and his daughter are disqualified persons, you represent that the investment transaction is between the Partnership itself and the IRA, and not with Mr. Adler and his family, except as fellow investors in the Partnership. Mr. Adler owns only 6.5 percent of the Partnership, and therefore the Partnership itself is not a disqualified person under section 4975(e)(2(G) of the Code which defines a disqualified person to include a corporation, partnership or trust or estate of which 50 percent or more of the capital interest is owned directly or indirectly, or held by persons described as fiduciaries.

“Based solely on the facts and representations contained in your submissions, it is the opinion of the Department that the IRA's purchase of an interest in the Partnership would not constitute a transaction described in section 4975(c)(1)(A) of the Code (prohibiting any direct or indirect sale or exchange or leasing of any property between a plan and a disqualified person).

“Whether the proposed transaction would violate sections 4975(c)(1)(D) and (E) of the code raises questions of a factual nature upon which the Department will not issue an opinion. A violation of section 4975(c)(1)(D) and (E) would occur if the transaction was part of an agreement, arrangement or understanding in which the fiduciary caused plan assets to be used in a manner designed to benefit such fiduciary (or any person [in] which such fiduciary had an interest which would affect the exercise of his best judgment as a fiduciary).

“In this regard, the Department notes Mr. Adler does not and will not receive any compensation from the Partnership and will not receive any compensation by virtue of the IRA's investment in the Partnership. However, the Department further notes that if an IRA fiduciary causes the IRA to enter into a transaction where, by the terms or nature of that transaction, a conflict of interest between the IRA and the fiduciary (or persons in which the fiduciary has an interest) exists or will arise in the future, that transaction would violate either 4975(c)(1)(D) or (E) of the Code. Moreover, the fiduciary must not rely upon and cannot be otherwise dependent upon the participation of the IRA in order for the fiduciary (or other persons in which the fiduciary has an interest) to undertake or to continue his or her share of the investment. Furthermore, even if at its inception the transaction did not involve a violation, if a divergence of interests develops between the IRA and the fiduciary (or persons in which the fiduciary has an interest), the fiduciary must take steps to eliminate the conflict of interest in order to avoid engaging in a prohibited transaction. Nonetheless, a violation of section 4975(c)(1)(D) or (E) will not occur merely because the fiduciary derives some incidental benefit from a transaction involving IRA assets.

“Moreover, the Department notes that by virtue of the contemplated investment by the IRA in the Partnership, there will be significant investment in the Partnership by benefit plan investors. See 29 CFR §2510.3-101(f). Accordingly, the partnership will hold ‘plan assets’ within the meaning of that term in the Department's regulations at 29 CFR §2510.3-101. As a result, any person who exercises discretionary authority or control with respect to assets of the Partnership will be a fiduciary of the IRA and subject to the restrictions of section 4975(c)(1) of the Code, except to the extent a statutory or administrative exemption applies.”—PWBA 2000 10A (the Adler case).

In 2002, the United States Tax Court ruled (in the Ancira case) that the IRA Beneficiary may facilitate a transaction for and on behalf of his IRA Account, and act as an agent or conduit for the IRA Account.—Robert Ancira v. Commissioner, 119 T. C. 6 (Docket No. 425-01, filed Sep. 24, 2002).

And, on Jan. 26, 2004, the Internal Revenue Service issued Notice 2004-8 (published in Internal Revenue Bulletin: 2004-4) entitled “Abusive Roth IRA Transactions”, which provides the most recent insight into the position of the IRS on transactions that it describes as “designed to avoid the statutory limits on contributions to Roth IRA contained in 408A.” Because of its importance, the Notice is included below in its entirety:

“NOTICE 2004-8, 2004-4 I.R.B. 333 (Jan. 26, 2004)

“Part III—Administrative, Procedural and Miscellaneous

“Abusive Roth IRA Transactions

“Notice 2004-8

“The Internal Revenue Service and the Treasury Department are aware of a type of transaction, described below, that taxpayers are using to avoid the limitations on contributions to Roth IRAs. This notice alerts taxpayers and their representatives that these transactions are tax avoidance transactions and identifies these transactions, as well as substantially similar transactions, as listed transactions for purposes of Section 1.6011-4(b)(2) of the Income Tax Regulations and Sections 301.6111-2(b)(2) and 301.6112-1(b)(2) of the Procedure and Administration Regulations. This notice also alerts parties involved with these transactions of certain responsibilities that may arise from their involvement with these transactions.

“Background

“Section 408A was added to the Internal Revenue Code by section 302 of the Taxpayer Relief Act of 1997, Pub. L. 105-34, 105^{th} Cong., 1^{st} Sess. 40 (1997). This section created Roth IRAs as a new type of nondeductible individual retirement arrangement (IRA). The maximum annual contribution to Roth IRAs is the same maximum amount that would be allowable as a deduction under section 219 with respect to the individual for the taxable year over the aggregate amount of contributions for that taxable year to all other IRAs. Neither the contributions to a Roth IRA nor the earnings on those contributions are subject to tax on distribution, if distributed as a qualified distribution described in section 408A(d)(2).

“A contribution to a Roth IRA above the statutory limits generates a 6-percent excise tax described in section 4973. The excise tax is imposed each year until the excess contribution is eliminated.

“Facts

“In general, these transactions involve the following parties: (1) an individual (the Taxpayer) who owns a pre-existing business such as a corporation or a sole proprietorship (the Business), (2) a Roth IRA within the meaning of section 408A that is maintained for the Taxpayer, and (3) a corporation (the Roth IRA Corporation), substantially all the shares of which are owned or acquired by the Roth IRA. The Business and the Roth IRA Corporation enter into transactions as described below. The acquisition of shares, the transactions or both are not fairly valued and thus have the effect of shifting value into the Roth IRA.

“Examples include transactions in which the Roth IRA Corporation acquires property, such as accounts receivable, from the Business for less than fair market value, contributions of property, including intangible property, by a person other than the Roth IRA, without commensurate receipt of stock ownership, or any other arrangement between the Roth IRA Corporation and the Taxpayer, a related party described in section 267(b) or 707(b), or the Business that has the effect of transferring value to the Roth IRA Corporation comparable to a contribution to the Roth IRA.

“Analysis

“The transaction described in this notice have been designed to avoid the statutory limits on contributions to a Roth IRA contained in section 408A. Because the Taxpayer controls the Business and is the beneficial owner of substantially all of the Roth IRA Corporation, the Taxpayer is in the position to shift value from the Business to the Roth IRA Corporation. The Service intends to challenge the purported tax benefits claimed for these arrangements on a number of grounds.

“In challenging the purported tax benefits, the Service will, in appropriate cases, assert that the substance of the transaction is that the amount of the value shifted from Business to the Roth IRA Corporation is a payment to the Taxpayer, followed by a contribution by the Taxpayer to the Roth IRA and a contribution by the Roth IRA to the Roth IRA Corporation. In such cases, the Service will deny or reduce the deduction to the Business; may require the Business, if the Business is a corporation, to recognize gain on the transfer under section 311(b); and may require inclusion of the payment in the income of the Taxpayer (for example, as a taxable dividend if the Business is a C corporation). See Sammons v. United States, 433 F.2d 728 (5^{th} Cir. 1970); Worchester v. Commissioner, 370 F.2d 713 (1^{st}. Cir. 1966).

“Depending on the facts of the specific case, the Service may apply section 482 to allocate income from the Roth IRA Corporation to the Taxpayer, Business, or other entities under the control of the Taxpayer. Section 482 provides the Secretary with authority to allocate gross income, deductions, credits or allowances among persons owned or controlled directly or indirectly by the same interests, if such allocation is necessary to prevent evasion of taxes or clearly to reflect income. The section 482 regulations provide that the standard to be applied is that of a person dealing at arm's length with an uncontrolled person. See generally section 1.482-1(b) of the Income Tax Regulations. To the extent that the consideration paid or received in transactions between the Business and the Roth IRA Corporation is not in accordance with the arm's length standard, the Service may apply section 482 as necessary to prevent evasion of taxes or clearly to reflect income. In the event of a section 482 allocation between the Roth IRA Corporation and the Business or other parties, correlative allocations and other conforming adjustments would be made pursuant to section 1.482-1(g). Also see, Rev. Rul. 78-83, 1978-1 C. B. 79

“In addition to any other tax consequences that may be present, the amount treated as a contribution as described above is subject to the excise tax described in section 4973 to the extent that it is an excess contribution within the meaning of section 4973(f). This is an annual tax that is imposed until the excess amount is eliminated.

“Moreover, under Section 408(e)(2)(A), the Service may take the position in appropriate cases that the transaction gives rise to one or more prohibited transactions between a Roth IRA and a disqualified person described in section 4975(e)(2). For example, the Department of Labor [FN #1—quoted below at [0123].] has advised the Service that, to the extent that the Roth IRA Corporation constitutes a plan asset under the Department of Labor's plan asset regulation (29 C.F.R. section 2510.3-101), the provision of services by the Roth IRA Corporation to the Taxpayer's Business (which is a disqualified person with respect to the Roth IRA under section 4975(e)(2)) would constitute a prohibited transaction under section 4975(c)(1)C). [FN #2—quoted below at [0124].] Further, the Department of Labor has advised the Service that, if a transaction between a disqualified person and the Roth IRA would be a prohibited transaction, then a transaction between that disqualified person and the Roth IRA Corporation would be a prohibited transaction if the Roth IRA may, by itself, require the Roth IRA Corporation to enter into the transaction. [FN #3—quoted below at [0125].]

“Listed Transactions

“The following transactions are identified as ‘listed transactions’ for purposes of sections 1.6011-4(b)(2), 301.6111-2(b)(2) and 301.6112-1 (b)(2) effective Dec. 31, 2003, the date this document is released to the public: arrangements in which an individual, related persons described in section 267(b) or 707(b), or a business controlled by such individual or related persons, engage in one or more transactions with a corporation, including contributions of property to such corporation, substantially all the shares of which are owned by one or more Roth IRAs maintained for the benefit of the individual, related persons described in section 267(b)(1), or both. The transactions are listed transactions with respect to the individuals for whom the Roth IRAs are maintained, the business (if not a sole proprietorship) that is a party to the transaction, and the corporation substantially all the shares of which are owned by the Roth IRAs. Independent of their classification as ‘listed transactions’, these transactions may already be subject to the disclosure requirements of section 6011 (section 1.6011-4), the tax shelter registration requirements of section 6111 (sections 301.6111-1T and 301.6111-2), or the list maintenance requirements of section 6112 (section 301.6112-1).

Substantially similar transactions include transactions that attempt to use a single structure with the intent of achieving the same or substantially same tax effect for multiple taxpayers. For example, if the Roth IRA Corporation is owned by multiple taxpayers' Roth IRAs, a substantially similar transaction occurs whenever that Roth IRA Corporation enters into a transaction with a business of any of the taxpayers if distributions from the Roth IRA Corporation are made to that taxpayer's Roth IRA based on the purported business transactions done with that taxpayer's business or otherwise based on the value shifted from that taxpayer's business to the Roth IRA Corporation.

“Persons required to register these tax shelters under section 6111 who have failed to do so may be subject to the penalty under section 6707(a). Persons required to maintain lists of investors under section 6112 who have fail [sic.] to do so (or who fail to provide such lists when requested by the Service) may be subject to the penalty under section 6708(a). In addition, the Service may impose penalties on participants in this transaction or substantially similar transactions, including the accuracy-related penalty under section 6662, and as applicable, persons who participate in the reporting of this transaction or substantially similar transactions, including the return preparer penalty under section 6694, the promoter penalty under section 6700, and the aiding and abetting penalty under section 6701.

“The Service and the Treasury recognize that some taxpayers may have filed tax returns taking the position that they were entitled to the purported tax benefits of the type of transaction described in this notice. These taxpayers should consult with a tax advisor to ensure that their transactions are disclosed properly and to take appropriate corrective action.

“Drafting Information

“The principal author of this notice is Michael Rubin of the Employee Plans, Tax Exempt and Government Entities Division. However, other personnel from the Service and Treasury participated in its development. Mr. Rubin may be reached at (202) 283-9888 (not a toll-free call).

“Footnotes

“FN 1/Under section 102 of Reorganization Plan No. 4 of 1978 (43 FR 47713), the Secretary of Labor has interpretative jurisdiction over section 4975 of the Internal Revenue Code.

“FN 2/For the Roth IRA Corporation to be considered as holding plan assets under the Department of Labor's plan asset regulation, the Roth IRA's investment in the Roth IRA Corporation must be an equity interest, the Roth IRA Corporation's securities must not be publicly-offered securities, and the Roth IRA's investment in the Roth IRA Corporation must be significant. 29 C.F.R. sections 2510.3-101(a)(2), 2510.3-101(b)(1), 2510.3-101(b)(2), and 2510.3-101(f). Although the Roth IRA Corporation would not be treated as holding plan assets if the Roth IRA Corporation constituted an operating company within the meaning of 29 C.F.R. section 2510.3-101(c), given the context of the examples described in this notice, it is unlikely that the Roth IRA Corporation would qualify as an operating company.

“FN 3/See 29. C.F.R. Section . [sic. No citation in original Notice.]”—IRS Notice 2004-8

Note that the Notice focuses on transfers of financial benefit from one Entity owned by the Beneficiary to the Roth Entity, by making an arranged sale between 2 entities controlled by the same person, for less than “fair value”. The Notice disclaims applicability to “debt”, and expressly says that it applies only where the Roth invests in “Equity” interests in the Roth IRA Corporation. The “constructive dividend” cases cited (i.e., Sammons v. United States, 433 F.2d 728 (5^{th} Cir. 1970); and Worchester v. Commissioner, 370 F.2d 713 (1^{st}. Cir. 1966)-) require that the transfer of the “financial benefit” from one entity to another must be the “equivalent” of a “distribution” to a common shareholder, followed by a “reinvestment” in the other entity, causing the shift in the “value” of the shareholder's interest from one company to the other. The Notice does not address any of the published cases or rulings (i.e., Swanson, Adler and Ancira) cited above, but does seem to indicate that where there is no transfer of a financial benefit from a pre-existing business owned by the IRA Beneficiary to the Beneficiary's IRA Plan, or where any such transfer occurs on terms that meet the “arms-length” standard of IRC 482, there is no violation of the IRC 4975 ‘prohibited transaction’ rules.

The other “exception”, mentioned in Footnote #2, is the reference to an “operating company” in the Dept. of Labor (DOL) regulations.

The “general rule” of 29 CFR 2510.3-101(b) is that:
“Generally, when a plan invests in another entity, the plan's assets include its investment, but do not, solely be reason of such investment, included any of the underlying assets of the entity. However, in the case of a plan's investment in an equity interest of an entity that is neither a publicly-offered security nor a security issued by an investment company registered under the Investment Company Act of 1940 its assets include both the equity interest and an undivided interest in each of the underlying assets of the entity, unless it is established that
   “(i) The entity is an operating company, or
   “(ii) Equity participation in the entity by benefit plan investors is not significant.
“Therefore, any person who exercises authority or control respecting the management or disposition of such underlying assets, and any person who provides investment advice with respect to such assets for a fee (direct or indirect), is a fiduciary of the investing plan.”DOL Reg.—29 CFR 2510.3-101(b)—underlining added for emphasis.

“Significant” is defined as amounting (together with other Plan investors) to 25% or more of the total equity ownership of the entity.—DOL Reg.—29 CFR 2510.3-101(f).

The “operating company” referenced in 29 CFR 2510.3-101(b)(i), above, is defined in 29 CFR 2510.3-101(c) as a company that is:
“engaged in the production or sale of a product or service other than the investment of capital. The term ‘operating company’ [also] includes an entity which is not described in the preceding sentence, but which is a ‘venture capital operating company’ described in paragraph (d) or a ‘real estate operating company’ described in paragraph (e).”—DOL Reg.—29 CFR 2510.3-101(c) —underlining added for emphasis.

“(d) . . . (1) An entity is a ‘venture capital operating company’ . . . if
“(i) at least 50 percent of its assets (other than short-term investments pending long-term commitment or distribution to investors), valued at cost, are invested in venture capital investments . . . ; and
“(ii) . . . the entity, in the ordinary course of its business, actually exercises management rights . . . with respect to one or more of the operating companies in which it invests.”—DOL Reg.—29 CFR 2510.3-101(d)—underlining added for emphasis.

“Venture capital investments” are defined as an “investment in an operating company (other than a venture capital operating company) as to which the investor has or obtains management rights.”—DOL Reg.—29 CFR 2501.3-101(d)(3)(i).

“Management rights” are defined as “contractual rights directly between the investor and an operating company to substantially participate in, or substantially influence the conduct of, the management of the operating company.”—DOL Reg.—29 CFR 2510.3-101(d)(3)(ii).

An entity is a ‘real estate operating company’, defined in 29 CFR 2510.3-101(e), if:
“(i) . . . at least 50 percent of its assets, valued at cost (other than short-term investments pending long-term commitment or distribution to investors), are invested in real estate which is managed or developed and with respect to which such entity has the right to substantially participate directly in the management or development activities; and
(ii) . . . such entity in the ordinary course of its business is engaged directly in real estate management or development activities.”—DOL Reg.—29 CFR 2501.3-101(e).

Thus, in summary, the “abusive Roth IRA transactions” referenced in IRS Notice 2004-8 do not include “debt” investment transactions or equity investment transactions with companies which are [1] “a publicly-offered security”, [2] a “registered” “investment company”, [3] “an operating company” “engaged in the production or sale of a product or service other than the investment of capital”, or [4] a “venture capital operating company” or [5] a “real estate operating company” as defined in the DOL Regs. in 29 CFR 2501.3-101, and appear to be limited only to those situations that are structured similar to the “constructive dividend” cases cited in Notice 2004-8, which involved a single stockholder who holds an interest in two corporations, followed by a transfer of assets from one corporation to the other which causes a shift in the “equity value” of the shares held by the common shareholder (i.e., increasing the “equity value” of one corporation's shares and simultaneously reducing the “equity value” of the other corporation's shares). This is a much narrower application than is suggested by the more expansive, but vague, language of Notice 2004-8, and is consistent with the Swanson, Adler and Ancira cases, which have not been distinguished by Notice 2004-8, and therefore appear to remain “good law”.

The Applicant believes that the cases and rulings summarized above (which include all pertinent cases and rulings known to the Applicant at this date) reflect the current state of the law with regard to the use of companies (i.e., partnerships, LLCs, trusts, corporations, etc.) to facilitate investments by and for the benefit of IRA and similar Pension Plan accounts, and that the invention described in this Application therefore represents a substantial advance in planning and investment structuring of great potential benefit to persons eligible to have and use IRAs and similar Pension Plans for “self-directed” investments. The Applicant also believes that the best resource for additional information regarding the current state of legal knowledge and understanding regarding the use and operation of IRA Accounts (including ROTH IRAs) is presented by the Bureau of National Affairs (BNA) in its comprehensive overview in Tax Portfolio #355—6^{th}: IRAs, SEPs and SIMPLEs, which is incorporated by this reference herein to the extent necessary to an understanding of the current state of the art in the field of the invention.

### BRIEF SUMMARY OF THE INVENTION

The invention describes a method to structure one or more Limited Liability Companies (or other entities with similar tax characteristics) so as to permit an IRA Beneficiary (or other Investment Manager for a “tax deferred” and/or “tax exempt” entity or account) to make investments without regard to the whether any particular investment will be “subject to” or “exempt from” the Unrelated Business Income Tax (“UBIT”), with the structure of the Company(ies) providing the mechanism by which those investments (and/or “attributes” of investments) which are “subject to” the UBIT are segregated from those investments (and/or “attributes” of investments) which are “exempt from” the UBIT, without requiring the IRA Beneficiary (or other Investment Manager) to determine in advance whether any particular investment is “subject to” or “exempt from” the UBIT, and without exposing the IRA to the risk of audit and taxation at the (currently higher) Trust Income Tax Rate.

The invention further describes a method to structure one or more Limited Liability Companies (or other entities with similar tax characteristics) to create “leverage” in order to increase the rate of return to one or more specific IRAs (e.g., ROTH IRAs and/or other “tax deferred” and/or “tax exempt” persons, entities or accounts which have been selected to be “favored” over “others”) without causing income that would otherwise be “exempt from” the UBIT to become “subject to” the UBIT on account of the use of “debt financing”.

The invention further describes a method to structure the ownership and operation of one or more Limited Liability Companies (or other entities with similar tax characteristics) in which an IRA Account (and/or other “tax exempt” or “tax deferred” entities or accounts) invests so that the Company does not violate the “prohibited transaction rules” in 26 USC 4975, while retaining sufficient flexibility for the IRA Beneficiary (or other Investment Manager for the “favored” persons, entities or accounts) to control the amount of income flowing to the Beneficiary as currently taxable income, versus the amount of income flowing to the IRA Account (and/or other “tax exempt” or “tax deferred” entities or accounts) for later use.

### DESCRIPTION OF THE DRAWINGS

DIAGRAM #1 illustrates the overall structure of the component parts of the structure comprising the invention.

Starting at the top of DIAGRAM #1, there is/are [1] the “EXEMPT Accounts”, comprised of One or More Individual Retirement Accounts, Pension Plan Accounts and/or other “tax exempt” or “tax deferred” Entities or Accounts, which provide the “majority” (more than 50%) of the “investment capital” for investment in the structure. These EXEMPT Accounts may be combined with [2] One or More Investments by members of the “Disqualified Persons” Group (as defined in 26 USC 4975(e)(2)-), which is permitted by 26 USC 4975(e)(2)(G), as long as the members of the “Disqualified Persons” Group “own” or “control” less than 50% of the “Total Equity Capital” (i.e., total invested by the EXEMPT Accounts and “Disqualified Persons”), as was approved in the Adler ruling (above at [0087]). Although a “majority” may be (strictly speaking) any percentage which is greater than 50%, I have used (for convenience in this Application) an illustrative allocation that is described as “51% or more” in the case of the EXEMPT Accounts, and “49% or less” in the case of the “Disqualified Persons” Group.

DIAGRAM #1 illustrates that the total of the “investment capital” available (from above) is invested into the capital structure of the two (2) Intermediate Entities, which are a “UBIT TAXABLE, LLC”, which elects (on IRS Form 8832) to be taxed as an “association taxable as a corporation”, and which will receive and pay tax on “income” that is “subject to” the Unrelated Business Income Tax (UBIT), and a “UBIT EXEMPT, LLC”, which retains the default “flow-through” tax treatment accorded to a Partnership, which will receive “income” that is “exempt from” the Unrelated Business Income Tax (UBIT). These two (2) entities (collectively referred to herein as the “Intermediate Entities”) are represented in the diagrams as “Limited Liability Companies” or “LLCs”, but could in fact be any entity that performs the same functions as are described for these two (2) LLCs. Thus, for example, a “State Chartered Corporation” or a “Massachusetts Business Trust” might be substituted for the UBIT TAXABLE, LLC, without altering the essential functional characteristics of the UBIT TAXABLE, LLC (i.e., the ability to “elect” to pay any required Income Tax at the (more favorable) “Corporate Tax Rates” specified in 26 USC 11 instead of the (less favorable) “Trust Tax Rates” specified in 26 USC 1(e)-). And, likewise, a “Partnership” or a “Grantor Trust” might be substituted for the UBIT EXEMPT, LLC, without altering the essential functional characteristics of the UBIT EXEMPT, LLC (i.e., the ability to “flow through” to Tax Exempt Entities and Accounts all income that is “exempt from” UBIT, free from Income Tax as to the Tax Exempt Entities and Accounts).

DIAGRAM #1 illustrates that the “investment capital” invested into each of the Intermediate Entities (above) is invested into a specially structured SEGREGATED SERIES, LLC, at the bottom of DIAGRAM #1, formed under the statutory law of a State which permits “segregated series” limited liability companies.

DIAGRAM #1 illustrates that the SEGREGATED SERIES, LLC, receives the “investment capital” from the two (2) Intermediate Entities (i.e., the UBIT TAXABLE, LLC, and the UBIT EXEMPT, LLC) and invests the “investment capital” to generate “income” that may be in part of a character that is “subject to” the UBIT, and in part of a character that is “exempt from” the UBIT.

And, DIAGRAM #1 illustrates that “income” received by the SEGREGATED SERIES, LLC, is allocated to the UBIT Taxable Series and then allocated/distributed to the UBIT TAXABLE, LLC, when such “income” is of a character that is “subject to” the UBIT. And, that “income” received by the SEGREGATED SERIES, LLC, is allocated to the UBIT Exempt Series, and then allocated/distributed to the UBIT EXEMPT, LLC, when such “income” is of a character that is “exempt from” the UBIT, and that each of the two (2) Intermediate Entities then allocates and/or distributes its “after tax” “net income” to the Individual Retirement Accounts and other “tax exempt” and/or “tax deferred” Entities and Accounts (and “Disqualified Persons”, if any are participating in a “minority” equity position) at the top of the DIAGRAM #1.

In the case of the UBIT TAXABLE, LLC, the “after tax” “net income” is that portion of the total “income” (after expenses, if any) that is “subject to” UBIT, which remains after payment of Income Tax at the Corporate Tax Rates specified in 26 USC 11. And, in the case of the UBIT EXEMPT, LLC, the “after tax” “net income” is the entire amount of the “net income” (after expenses, if any) available for allocation/distribution, since the UBIT EXEMPT, LLC, receives only “income” that is “exempt from” the UBIT. Note that any members of the “Disqualified Persons” Group who receive an allocation/distribution from the UBIT EXEMPT, LLC, will remain taxable on the amount of “income” received under the normal Income Tax rules, while the EXEMPT Accounts will receive their allocation/distribution of “income” free from Income Tax, since the EXEMPT Accounts are not taxable under the normal Income Tax rules, and the UBIT EXEMPT, LLC, receives allocations/distributions only of “income” that is “exempt from” the UBIT (which is the only Income Tax, other than various penalties for prohibited transactions, applicable to EXEMPT Entities and Accounts).

DIAGRAM #1 also illustrates that the UBIT TAXABLE, LLC, holds an interest only in the “UBIT Taxable Series” of the SEGREGATED SERIES, LLC, and the UBIT EXEMPT, LLC, holds an interest only in the “UBIT Exempt Series” of the SEGREGATED SERIES, LLC, while all uninvested funds and funds awaiting distribution are held in the “Cash Account” (or “Cash Series”) of the SEGREGATED SERIES, LLC, until invested by the Company's Investment Manager, without regard to which of the “segregated series” the “tax attributes” of the investments may ultimately be allocable.

And, DIAGRAM #1 also illustrates the inclusion of a “Prohibited Transaction Series” which allocates/distributes directly to the IRA Beneficiary (in the case of IRA Accounts) or other Account Beneficiary as to any “investment” made, which violates the “prohibited investment” rules in 26 USC 408, or the “prohibited transaction rules” in 26 USC 4975, notwithstanding specific prohibitions contained in the Operating Agreement of the SEGREGATED SERIES, LLC, which prohibit any “investments” and/or “transactions” which would violate the “prohibited investments” and/or “prohibited transaction” rules. The principal anticipated use of the “Prohibited Transaction Series” is to deal with any inadvertent “prohibited investments” since the violation of any of the “prohibited transaction” rules in 26 USC 4975 causes the “termination” of the entire IRA Account. Since the making of any “investment” that is “prohibited” by 26 USC 408 is treated as a “distribution” from the IRA Account, this “allocation” reflects the “tax treatment” required by 26 USC 408. On the other hand, when there are sufficient funds available from the members of the “Disqualified Persons” Group to have made the “prohibited investment”, the “prohibited investment” may be deemed to have been made from those funds rather than from the funds of the IRA Account, thus potentially avoiding the “constructive distribution” from the IRA Account required by 26 USC 408 when IRA funds are used to make a “prohibited investment”. Without demeaning the importance of the “Prohibited Transaction Series”, it is ignored in the other Diagrams, since its intended use is only as a “safety valve” to avoid allocation of an “inadvertent” “prohibited investment” to an IRA Account, rather than as an essential element of the leverage and segregation benefits permitted by the use of the SEGREGATED SERIES, LLC, and the Intermediate Entities, within this structure.

DIAGRAM #2 illustrates that leverage can be gained in the Intermediate Entities by the use of a “Capital Structure” which is comprised of a “Common Class” and a “Preferred Class” of Units or Interests. Although the use of “Common Stock” and “Preferred Stock” is common place in the structuring of the “equity ownership” of corporations, a similar structure of the “equity ownership” is permissible in a Limited Liability Company also. DIAGRAM #2 illustrates that a Capital Structure which is composed of 80% “Preferred Class” (with a 6% “Preference Right” to allocations/distributions) and 20% “Common Class” (subordinated to the “Preference Right” of the “Preferred Class”), can increase the Return on Investment (ROI) to the “Common Class” from 12% (the average ROI on the total capital invested in the illustration) to 27% ROI “after tax” to the “Common Class” from the UBIT TAXABLE, LLC, and as much as 36% ROI to the “Common Class” from the UBIT EXEMPT, LLC.

DIAGRAM #2 also adds the mandatory condition that the “capital investments” made by the EXEMPT Accounts (and “Disqualified Persons”, if any are participating) must be in “equal percentage amounts” into the “Preferred Class” and the “Common Class” in each of the Intermediate Entities. The requirement that the available “investment capital” be invested in “equal percentage amounts” into the two (2) Intermediate Entities might be understood to require that the dollar amount invested into the UBIT TAXABLE, LLC must be equal to the dollar amount invested into the UBIT EXEMPT, LLC. However, that is not what is meant by the requirement that the investment be in “equal percentage amounts”.

Instead, what is meant by the “equal percentage amount” requirement is that the “amount invested” into the “Preferred Class” and into the “Common Class” in each of the Intermediate Entities represent the same “percentage allocation” of the investment into each “Class” in the Intermediate Entities, rather than the same “dollar amount” of investment into each “Class”. So, for example, if the particular client for whom the structure is designed anticipates that the bulk of the “income” generated will be “exempt from” UBIT (due to the nature of the contemplated investments), the amount of the “investment capital” actually invested into the UBIT TAXABLE, LLC might be quite small (e.g., $900 [i.e., 90%] into the “Preferred Class” and only $100 [i.e., 10%] into the “Common Class” of Units or other Equity Interests), for a total Equity Capital in the UBIT TAXABLE, LLC of only $1,000 [i.e., 100%]. And, the vast majority of the “investment capital” might be invested into the UBIT EXEMPT, LLC (e.g., $900,000 [i.e., 90%] into the “Preferred Class” and $100,000 [i.e., 10%] into the “Common Class” of Units or other Equity Interests) for a total Equity Capital in the UBIT EXEMPT, LLC of $1,000,000 [i.e., 100%]. And, if the expectation is that the client for whom the structure is designed will more likely generate “income” that is “subject to” the UBIT, the allocation of the “capital investment” might be exactly the opposite. Or, depending on the anticipated “character” of the “income” to be generated (i.e., “subject to” versus “exempt from” UBIT), any allocation in between. Thus, the important allocation is the “percentage” of the total “capital investment” into each Intermediate Entity that is invested into the “Preferred Class”, versus the “percentage” of the total “capital investment” that is invested into the “Common Class” in each of the Intermediate Entities, which must be “identical” in order to eliminate the “discrimination” that could otherwise occur against an EXEMPT Account caused by or arising from a difference in the “percentage” ownership of the “Common Classes” and “Preferred Classes” in the two (2) Intermediate Entities.

DIAGRAM #3 illustrates that the amount of “leverage” (without “debt financing”) in favor of the “Common Class” increases as the “percentage” of the “total capital” of each Intermediate Entity that is invested in the “Preferred Class” increases above the 80/20 allocation illustrated in DIAGRAM #2. The aggressive allocation of “capital invested” 90% to the “Preferred Class” in DIAGRAM #3 (instead of 80% as in DIAGRAM #2) causes the 12% overall ROI generated on “total capital” (the same ROI as illustrated in DIAGRAM #2) to increase the ROI allocable to the “Common Class” (after first satisfying the “preference rights” of the “Preferred Class”) to nearly double, to a 48% ROI to the “Common Class” from the UBIT TAXABLE, LLC, and to a 66% ROI to the “Common Class” from the UBIT EXEMPT, LLC.

Thus, DIAGRAM #3 illustrates how an Equity Capital Structure can be created which will generate substantial “leverage” in favor of a ROTH IRA (and other “Common Class” investors holding only 10% of the total Equity Capital), by the allocation of a 90% of the Equity Capital to a “Preferred Class” which receives only a specified and limited “Preferred Annual Return” (and possibly a “Priority Return of Capital” on liquidation of the Company), without the use of any “debt financing” in either of the Intermediate Entities, which would cause ALL of the investment “income”, “gains” and “profits” generated in the SEGREGATED SERIES, LLC, to become subject to the UBIT (26 USC §511-514).

DIAGRAM #4 further illustrates how the ROI to the “Common Class” can be further leveraged (without use of “debt financing”) by increasing the percentage of total Equity Capital held by the “Preferred Class” to 99% and reducing the percentage held by the “Common Class” to only 1% of the total Equity Capital, which can provide very great leverage to accelerate the “accumulation” of substantial wealth in a ROTH IRA (which is not subject to income tax when withdrawn in retirement, after age 59½), by leveraging against funds already accumulated in Traditional IRAs and other Pension Accounts (as well as investable funds from members of the “Disqualified Persons” Group). As illustrated in DIAGRAM #4, the 12% overall ROI earned on the total capital invested will now be allocable 6% as the ROI to the “Preferred Class”, causing a 426% ROI “after tax” to the “Common Class” from the UBIT TAXABLE, LLC, and a 606% ROI to the “Common Class” from the UBIT EXEMPT, LLC. Since there is no “upper limit” or “lower limit” on how much of the overall Equity Capital is allocated to the “Preferred Class” or to the “Common Class”, the leverage that can be achieved (without “debt financing”) is almost “infinite”, under the right circumstances. Thus, very small amounts of “non-deductible contributions” into a ROTH IRA can be structured to cause very large “investment” profits to flow into a “never to be taxed” ROTH IRA Account.

DIAGRAM #5 illustrates how “debt financing” can be used by investment from the SEGREGATED SERIES, LLC, into a SUBSIDIARY DEBT-FINANCED, LLC, in addition to the “leverage” provided by the 99% “Preferred Class” and 1% “Common Class” of Equity Capital, to provide an even greater “acceleration” of wealth accumulation, which can be particularly attractive to ROTH IRA Accounts (which are not subject to income tax when withdrawn in retirement after age 59½). As illustrated in DIAGRAM #5, much larger investment gains can be generated when “debt financing” is used in the structure. Such “debt financing” which occurs in an “investment entity” (such as the SUBSIDIARY DEBT-FINANCED, LLC, shown in DIAGRAM #5) causes the “income” generated to be “subject to” UBIT. But, as illustrated in DIAGRAM #5, the ROI to the “Common Class” (all ROTH IRAs in the illustration) can become nearly “astronomical” (e.g., 7,181% ROI from the UBIT TAXABLE, LLC, in addition to 366% ROI from the UBIT EXEMPT, LLC), while the “Preferred Class” continues to receive its 6% “Preference Right” Return on Investment (ROI).

DIAGRAM #6 illustrates how an investment strategy using Stock Options or Options on Stock Indexes can also generate very large gains that are allocated by the 99% Preferred and 1% “Common Class” “Capital Structure” primarily to the benefit of the “Common Class” (all ROTH IRAs in the illustration). Note that, as long as there is no use of “margin” (i.e., “debt financing”) in the purchase and resale of the Stock Options or Index Options as in the illustration, the “income” generated is entirely “exempt from” the UBIT under 26 USC 512(b)(1) & (5). As a result the “income” is allocated to the UBIT Exempt Series, and allocated/distributed to the UBIT EXEMPT, LLC, free from all “income tax” to the EXEMPT Accounts (such as the ROTH IRA, the Traditional IRA and other Pension Accounts and “Tax Exempt” Entities). In DIAGRAM #6, actual Index Option Trades are illustrated which produced a $34,150 “profit” over an 18 day period in 2005, when the SPX (S & P 500 Index) rose from 1,207.01 at the close of trading on Oct. 31, 2005, to 1,248.27 at the close of trading on Nov. 18, 2005, producing a $33,850 “profit” on a “Synthetic Long” position. The “Synthetic Long” position is opened by the “purchase” of 10 SPX CALL Options at the “strike price” of 1,210 at the $12.50 ASK Price (total purchase price=$12,500), and the simultaneous “sale” of 10 SPX PUT Options at the same “strike price” at the $14.50 BID Price (total sale proceeds=$14,500), for a $2,000 increase in “cash” available in the Margin Account, but no use of “Margin” (and thus no “debt financing”). Then, on Nov. 18, 2006, the “Synthetic Long” position is “closed” by the “sale” of the 10 SPX CALL Options (previously purchased) at the $32.00 BID Price (total sale proceeds=$32,000), and the “purchase” of the 10 SPX PUT Options (previously sold) at the $0.15 ASK Price (total purchase price=$150), producing and additional increase in “cash” available in the Margin Account (without use of a Margin Loan and therefore no “debt financing”) of $31,850, for a total “round turn” profit of $33,850. Also, since the assumed $100,000 available in the Margin Account was not used for any other purpose, it would have been available to earn “interest” in the Broker's Money Market Account, which is assumed to be approximately 3.5% or $3,500 over the year. DIAGRAM #6 then illustrates how the “Preferred Class” receives their 6% “Preference Right” on the $99,000 invested in the “Preferred Class”, and the “Common Class” receives the remainder (after satisfying the “Preference Right” of the “Preferred Class”), for a 3,141% ROI to the “Common Class” (which is composed entirely of ROTH IRA Accounts in this illustration). Since this illustration demonstrates the profit potential from only one transaction, which required only 18 days to produce the illustrated profit on the Option on the S & P 500 Index, it is quite clear that investors who focus on “Stock Options” and “Index Options” can generate very large profits over an entire year, which can be complete “tax free” to ROTH IRAs and other EXEMPT Entities and Accounts, as long as there is no use of a “margin loan” in the Margin Account. (Note that the UBIT TAXABLE, LLC, is omitted from the DIAGRAM #6, since not relevant to this illustration.)

DIAGRAM #7 illustrates how the Option Strategy (applied to the Stock Market in DIAGRAM #6) can be applied to investments in Real Estate. In DIAGRAM #7, the SEGREGATED SERIES, LLC, acquires an “out-of-the-money” Option to Purchase a parcel of Real Property (with an assumed “fixer-upper” house on the Property), and the IRA Beneficiary (a “Disqualified Person” within the meaning of 26 USC 4975(e)-) simultaneously (in the same closing and from the same Seller) acquires the Real Property “subject to” the Option to Purchase. An “out-of-the-money” Option to Purchase represents the “right” to pay “too much” for the Property, which is not generally considered to be a “very valuable” right. Therefore, the SEGREGATED SERIES, LLC purchases the “out-of-the-money” Option for only $1,000 in this illustration (some purchases can be for as little as $100.00). The “out-of-the-money” Option illustrated in DIAGRAM #7 represents the “right to buy” the Property (currently worth only $100,000) for $140,000, and the IRA Beneficiary completes the purchase at the current value of only $100,000 (“subject to” the Option issued by the Seller to the SEGREGATED SERIES, LLC). After the IRA Beneficiary invests $30,000 or so (and possibly considerable effort) to “renovate” the house on the Property, the Property (with “renovated” house) is now assumed to be “Re-Sold” for its increased value of $240,000. The SEGREGATED SERIES, LLC (which holds the Option to Purchase) does not “exercise” the Option, but instead elects to permit the Option to be “extinguished” in the “Re-Sale” closing. The Closing Agent, therefore allocates the first $140,000 of the “Re-Sale Proceeds” to the IRA Beneficiary, who makes a “small profit” on the sale, after re-paying any “debt financing” used to make the purchase and repayment of the “renovation” costs. The Closing Agent is required by the Option to Purchase held by the SEGREGATED SERIES, LLC to allocate all of the “Re-Sale Proceeds” above the $140,000 Option Price to the SEGREGATED SERIES, LLC in consideration for the “extinguishment” of the Option, so that “clear title” can be delivered to the Purchaser on the Re-Sale of the property.

Since the Option is never “exercised”, and the Option Holder (i.e., the SEGREGATED SERIES, LLC) does not use any “debt financing” to “purchase” the Option, the entire “proceeds” received by the SEGREGATED SERIES, LLC upon “extinguishment” of the Option at the Re-Sale of the Property is “exempt from” UBIT, and can pass through the UBIT EXEMPT, LLC with no income tax payable by the EXEMPT Accounts. Although the IRA Beneficiary, who is a “Disqualified Person”, may use “debt financing” to acquire and “renovate” the Property, that “debt financing” is not attributable to the IRA Account of the Beneficiary, since they own distinctly different “property interests” in the Property. (Note that the UBIT TAXABLE, LLC is omitted from the DIAGRAM #7, since not relevant to this illustration.)

The illustrated “profit” of approximately $100,000 on the “fixer-upper” is representative of typical clients who are engaged in this type of investing. And, as illustrated in DIAGRAM #7, the effect of the large leverage causes the “Preferred Class” to receive its 6% “Preference Right” and the “Common Class” (which is ALL ROTH IRA Accounts in the illustration) to receive a 10,594% ROI on its $1,000 Capital Investment in the “Common Class”.

DIAGRAM #8 illustrates how the capital structure of the UBIT EXEMPT, LLC (and the UBIT TAXABLE, LLC, with identical capital structure) permit the IRA Beneficiary to participate during the first part of the tax year (in up to 49% of the profits), and by simply withdrawing most of the Capital invested in the “Common Class” of the Company (i.e., all except $1.00 to keep the Capital Account open) to stop virtually all further allocations of “taxable profits” to the IRA Beneficiary, and cause virtually all “future profits” generated to become allocable to the ROTH IRA (or other EXEMPT Entity or Account), as almost the sole remaining member of the “Common Class” of Equity Interests in the UBIT EXEMPT, LLC, after all except $1.00 has been withdrawn from the Equity Capital invested by the IRA Beneficiary in the “Common Class”.

Neither the “prohibited transaction” rules of 26 USC 4975, nor the prohibition against making a “contribution” to an IRA Account (in 26 USC 408 & 408A) are broken by the IRA Beneficiary “withdrawing” Capital from his “Common Class” Account, as long as the withdrawal of “capital” occurs after the SEGREGATED SERIES, LLC (and the Intermediate Entity, if any), “suspend” investment activities and “distribute” all of their “profits” earned prior to the date of the withdrawal of “capital”. And, likewise, none of the “prohibited transaction” rules are broken by an IRA Beneficiary who later decides to increase his “percentage” ownership of the Equity Capital in the investment entity, as long as all participants are invested before the “next round” of investment activity begins. Thus, the structure of the LLCs provides very great flexibility to astute investors to decrease and increase their respective “equity ownership” of the Intermediate LLCs, as long as the EXEMPT Entities and Accounts maintain at all times an “equity ownership” which is “more than 50%” of the total Equity Capital, and the “equity ownership” of the “Disqualified Persons” Group is at all times “less than 50%” of the total Equity Capital in the LLC.

Also, the Swanson case (above at [0032]) and the Field Service Advice (above at

show that up to 100% of an Entity's Equity Capital may be owned by IRA Accounts (including ROTH IRA Accounts, as well as other EXEMPT Entities and Accounts), and the Adler case (above at [0087]) shows that there is no “prohibited transaction” problem merely because an EXEMPT Entity or Account invests along with a “Disqualified Person”, as long as the “equity investment” is made in advance of the production of the “investment returns”, and the Ancira case (above at [0096]) shows that there is no “prohibition” against an IRA Beneficiary “facilitating” any investment activity which benefits the IRA Account, as long as the IRA Beneficiary does not receive any “compensation” or other “benefit” for his/her services with respect to the “investment” (which compensation is prohibited by 26 USC 4975(c)(1)(F)-).

### DETAILED DESCRIPTION OF THE INVENTION

The essence of the invention is the method of using of a “segregated series” Limited Liability Company (“LLC”), organized under the statutes of a jurisdiction which permits “statutory segregated series” LLCs, to “segregate” and “allocate” income, gains and profits according to whether the “tax attributes” of the income, gains and profits cause the particular income, gains and profits to be “subject to” or “exempt from” the Unrelated Business Income Tax (the “UBIT”).

The ordinary way of creating a “segregated series” within a “statutory segregated series” LLC is to allocate Equity Capital, “investment assets” and “liabilities” to a particular “series”, which is then operated as a “separate and distinct” compartment (the “separate segregated series”) which is legally distinct (under the statute) from the Company in general and from any other “segregated series” of the Company. When so “segregated”, with “separate and distinct” records maintained by the Company for each such “segregated series”, the Equity Capital and “assets” of the “segregated series” are exposed only to the “liabilities” of that particular “segregated series”, and creditors with claims against the “assets” of a particular “segregated series” are permitted to assert their claims against, and to lien, seize and sell, pursuant to a Judgment obtained against the particular “series”, ONLY the “assets” of that particular “segregated series”, and such creditors have no rights against the “assets” held in some other “segregated series” or against the Company in general.

The invention, however, disregards these traditional ways of designing a “segregated series” Limited Liability Company, and uses the concept of “segregated series” in a completely different way. Instead of describing the “segregated series” as a separation of “equity”, “assets” and “liabilities” the invention describes each “segregated series” in terms of the “tax attributes” of the income, gains and profits generated by the Company's investments. Used in this way, the Company loses the ability to “separate” Equity Capital, “assets” and “liabilities” into separate “segregated series”, but gains the ability to have an automatic “segregation” of “tax attributes”, by virtue of the allocation of income, gains and profits which are “subject to” the Unrelated Business Income Tax (UBIT) to a separate “segregated series” (e.g., the “UBIT Taxable Series”), and the allocation of income, gains and profits which are “exempt from” the UBIT to another separate “segregated series” (e.g., the “UBIT Exempt Series”).

In addition, the use of the “segregated series” as a method of “segregating” the “tax attributes” of investments also permits the creation of a “Prohibited Transaction Series” (an optional series) for investments that are “prohibited” to IRA Accounts under 26 USC 408, which may inadvertently occur from time to time, thus providing some protection to the IRA Beneficiary from an inadvertent “distribution” from his/her IRA Account (and the tax consequences of such inadvertent distribution, including the “ordinary income tax” and the “10% penalty tax” on early “distributions” under 26 USC 408), if there are any other funds invested in the SEGREGATED SERIES, LLC, to which the “prohibited investment” may be attributed. However, a violation of the “prohibited transaction” rules in 26 USC 4975 (even though “inadvertent”) causes the “termination” of the entire IRA Account, and therefore the inclusion of the “Prohibited Transaction Series” does not prevent the “termination” required by 26 USC 408(e)(2).

The easiest way to visualize the investment and “automatic” allocation process is as a diamond shape, with one or more Retirement Accounts (e.g., IRA or other “tax exempt” or “tax deferred” entity or account) investing in the Equity Capital of each of the Intermediate Entities located at the center line of the diamond shape (e.g., the UBIT TAXABLE, LLC on one side, and the UBIT EXEMPT, LLC on the other side of the diamond shape), and that each of these LLCs then invests into the SEGREGATED SERIES, LLC at the bottom of the diamond shape, as illustrated in DIAGRAM #1.

In order to keep audits away from the Retirement Accounts, and to take advantage of the currently lower Income Tax Rates available to corporations, the UBIT TAXABLE, LLC files IRS Form 8832 with the Internal Revenue Service, and elects (on the Form 8832) to be taxed as an “association taxable as a corporation”, and thereafter files IRS Form 1120 (the Corporation Tax Return) for each year that it remains in operation.

Assuming more than one person, entity or account has an Equity Capital investment in the UBIT EXEMPT, LLC, the UBIT EXEMPT, LLC will be treated as a “partnership” for U.S. Federal Income Tax purposes under the default rules in 26 CFR 301.7701, and will file IRS Form 1065 (the Partnership information return) for each tax year that it remains in operation.

The SEGREGATED SERIES, LLC, since it always has at least two Members (e.g., the UBIT TAXABLE, LLC and the UBIT EXEMPT, LLC, in addition to other possible Members, such as “Disqualified Persons”), will be treated as a “partnership” for U.S. Federal Income Tax purposes under the default rules in 26 CFR 301.7701, and will file IRS Form 1065 (the Partnership information return) for each tax year that it remains in operation.

In exchange for the investment by the UBIT TAXABLE, LLC, a “securities certificate” is issued by the SEGREGATED SERIES, LLC to (or an “uncertificated” interest, described in the Operating Agreement of the SEGREGATED SERIES, LLC, is allocated to) the UBIT TAXABLE, LLC allocating ALL (100%) of the Membership Interest in the “UBIT Taxable Series” of the SEGREGATED SERIES, LLC, regardless of the dollar amount invested as a percentage of the total equity capital invested into the SEGREGATED SERIES, LLC.

And, in exchange for the investment by the UBIT EXEMPT, LLC, a “securities certificate” is issued by the SEGREGATED SERIES, LLC to (or an “uncertificated” interest, described in the Operating Agreement of the SEGREGATED SERIES, LLC, is allocated to) the UBIT EXEMPT, LLC, as to ALL (100%) of the Membership Interest in the “UBIT Exempt Series”, regardless of the dollar amount invested as a percentage of the total equity capital invested into the SEGREGATED SERIES, LLC.

The investment proceeds (presumably “cash”) received by the SEGREGATED SERIES, LLC may be held in a “Cash Account” or a separate “segregated” “Cash Series” of the SEGREGATED SERIES, LLC until invested.

The SEGREGATED SERIES, LLC now makes an investment, which may generate income, gains or profits which are “exempt from” or “subject to” the UBIT. The Investment Manager making the investment does not need to determine whether the income, gains or profits are “subject to” or “exempt from” the UBIT prior to making the investment, and therefore may make the investment without consulting with a Tax Professional at the time of, or prior to, making the investment.

At the end of the tax year, a Tax Professional reviews all pertinent information regarding each investment made and/or held during the tax year, and allocates the income, gains and profits realized to either: [a] the “UBIT Exempt Series“; or [b] the “UBIT Taxable Series“; or [c] the “Prohibited Transaction Series” (if applicable); and prepares the SEGREGATED SERIES, LLC's 1065 Income Tax Return, and K-1s, accordingly.

The Tax Professional then issues a K-1 to the UBIT EXEMPT, LLC, reflecting the amount of the UBIT Exempt income, gains and profits allocated to the “UBIT Exempt Segregated Series”, and issues a separate K-1 to the UBIT TAXABLE, LLC, reflecting the amount of the UBIT Taxable income, gains and profits allocated to the “UBIT Taxable Segregated Series” in the SEGREGATED SERIES, LLC.

IF there happens to be any “prohibited investment” (e.g., a purchase of “insurance” prohibited by 26 USC 408(e)(5)(B) or “collectibles” prohibited by 26 USC 408(m)-) during the applicable period, the Tax Professional can also issue a K-1 reflecting the allocation of the “prohibited investment” to the IRA Beneficiary, either as a “premature distribution” from the IRA Account, or as a “special allocation” from the funds invested by the IRA Beneficiary (as a member of the “Disqualified Persons” Group).

IF the Tax Professional makes a “mistake” in the allocation of the income, gains and profits which are “exempt from” UBIT or “subject to” UBIT, which mistake is later discovered on audit by the Internal Revenue Service, the adjustment required to correct the “mistake” can be made in the 1065 Tax Return of the SEGREGATED SERIES, LLC, and in the 1120 Tax Return of the UBIT TAXABLE, LLC and/or in the 1065 Tax Return of the UBIT EXEMPT, LLC, without necessarily causing an audit of the ultimate investors (i.e., the “tax exempt” or “tax deferred” entities and accounts) who hold the Equity Capital in the UBIT TAXABLE, LLC and/or the UBIT EXEMPT, LLC, since the adjustment in the tax return of the SEGREGATED SERIES, LLC will be reflected on an Amended K-1 issued to the UBIT TAXABLE, LLC, and the UBIT EXEMPT, LLC, while the additional tax payment or refund will be reflected in their current financial records.

For example, if the “mistake” involved an erroneous allocation of an item to the UBIT EXEMPT, LLC, instead of to the UBIT TAXABLE, LLC, the “correction” will involve a reallocation of the item to the UBIT TAXABLE, LLC, which will then pay the amount of additional income tax on an Amended 1120 Tax Return, and reflect the additional payment in its current financial records as a reduction in its cash balance, and increase in income tax expense. And, the converse, if the “mistake” involved an erroneous allocation to the UBIT TAXABLE, LLC (causing a tax overpayment for the prior period, and a tax refund in the current period), which should have been allocated to the UBIT EXEMPT, LLC. In either circumstance, the necessity for the IRS to perform an “audit” of the ultimate “tax exempt” or “tax deferred” Entities or Accounts is reduced or eliminated.

The UBIT EXEMPT, LLC “receives” the allocation of the income, gains and profits which are “exempt from” the UBIT, and prepares a 1065 Tax Return which allocates such income, gains and profits among its Members (i.e., the holders of its Equity Capital) in proportion to their respective interests in the Equity Capital in the UBIT EXEMPT, LLC, without payment of any UBIT on the UBIT Exempt income, gains and profits.

The UBIT TAXABLE, LLC “receives” the allocation of the income, gains and profits which are “subject to” the UBIT, prepares an 1120 Tax Return, pays the UBIT at the Corporate Tax Rate, and then distributes the funds remaining “after tax” to its Members (i.e., the holders of its Equity Capital) as “dividends” which are “exempt from” UBIT as/when received by “tax exempt” and “tax deferred” entities and accounts.

The allocations “received” by the UBIT EXEMPT, LLC and the UBIT TAXABLE, LLC from the SEGREGATED SERIES, LLC, may be accompanied by an actual cash “distribution” of the income, gains and profits, or such cash may be reinvested without actual “distribution” to the UBIT EXEMPT, LLC, and/or the UBIT TAXABLE, LLC, as the Investment Manager of the SEGREGATED SERIES, LLC, determines to be appropriate from time to time.

The “equity interests” in the UBIT TAXABLE, LLC and in the UBIT EXEMPT, LLC may be partially owned by persons who are “Disqualified Persons” as defined in 26 USC 4975(e), as long as the total “equity ownership” by “Disqualified Persons” represents “less than 50%” of the total “equity interests” in each class of Equity Capital of the UBIT TAXABLE, LLC, and of the UBIT EXEMPT, LLC.

IF the “equity interests” of the “Disqualified Persons” meet the test in the preceding paragraph, the “equity interests” in the UBIT TAXABLE, LLC and in the UBIT EXEMPT, LLC may be partially owned by IRAs and other “tax exempt” and “tax deferred” Entities and Accounts, provided the total “equity ownership” by the “Disqualified Persons” represents at all times “less than 50%” of the total Equity Capital in each “Class”, and overall, in the UBIT TAXABLE, LLC and in the UBIT EXEMPT, LLC, at all times that the “Disqualified Persons” have any investment in the Equity Capital of the UBIT TAXABLE, LLC and in the UBIT EXEMPT, LLC.

The “equity interests” in the UBIT TAXABLE, LLC may be structured similar to the capital structure of a corporation, with a “Common Class” of Equity Capital, whose rights and interests are subordinated to a “Preferred Class” of Equity Capital. The “Preferred Class” of Equity Capital may have a “Preference Right” to receive specified amount (in the nature of a “preferred dividend”) as a “distribution” prior to the allocation of any “distribution” to the “Common Class”. The “Preference Right” may be “cumulative” (i.e., with a “carry-over” of any “deficiency” or “short-fall” in payment of the “preferred dividend” to future years, until paid), or “non-cumulative” (i.e., with no “carry-over” of any “deficiency” or “short-fall” to future years, when there are insufficient “profits” to pay the “preferred dividend” in a particular year). The “Preferred Class” may also be granted a “Priority Right” to receive an amount equal to “return of invested capital” upon liquidation of the UBIT TAXABLE, LLC, before any “liquidating distributions” are made to the “Common Class”.

The “equity interests” in the UBIT EXEMPT, LLC may also be structured similar to the capital structure of a corporation, with a “Common Class” of Equity Capital, whose rights and interests are subordinated to a “Preferred Class” of Equity Capital, and with the “Preferred Class” of Equity Capital having a “Preference Right” to receive specified “dividend distributions” prior to the allocation of any “dividend distributions” to the “Common Class”, and/or with a “Priority Right” in favor of the “Preferred Class” to receive “return of invested capital” upon liquidation of the UBIT EXEMPT, LLC.

When the overall “after tax” Return on Investment (ROI) to the UBIT TAXABLE, LLC exceeds the “Preference Right” of the “Preferred Class”, there is “positive leverage” that works in favor of the “Common Class” to cause the “Common Class” to receive a larger percentage of the “after tax” “distributable earnings and profits” of the UBIT TAXABLE, LLC, than when the “after tax” ROI is equal to or less than the “Preference Right” of the “Preferred Class”.

And, when the overall “after tax” ROI to the “equity interest holders” in the UBIT TAXABLE, LLC is less than the “Preference Right” of the “Preferred Class”, there is “negative leverage” that works against the “Common Class” to cause the “Common Class” to receive a lesser percentage of the “after tax” “distributable earnings and profits” of the UBIT TAXABLE, LLC, than when the “after tax” ROI is equal to or greater than the “Preference Right” of the “Preferred Class”.

When the overall ROI to the UBIT EXEMPT, LLC exceeds the “Preference Right” of the “Preferred Class”, there is “positive leverage” that works in favor of the “Common Class” to cause the “Common Class” to receive a larger percentage of the “distributable earnings and profits” of the UBIT EXEMPT, LLC, than when the rate of return is equal to or less than the “Preference Right” of the “Preferred Class”.

When the overall ROI to the UBIT EXEMPT, LLC is less than the “Preference Right” of the “Preferred Class”, there is “negative leverage” that works against the “Common Class” to cause the “Common Class” to receive a lesser percentage of the “distributable earnings and profits” of the UBIT EXEMPT, LLC, than when the rate of return is equal to or greater than the “Preference Right” of the “Preferred Class”.

In general, it is preferable to set the “Preference Right” of the “Preferred Class” at a rate that is equal to or greater than the “weighted average interest rate” specified by the Internal Revenue Service (IRS) under 29 USC 412(b)(5)(B) and 412(l)(7)(C)(i), which is used to calculate the current liability of employers for purposes of determining the full funding limitation under §412(c)(7), and the required contribution under §412(l), for Defined Benefit Plans, in order to avoid any claim of “discrimination” which might otherwise be asserted by the Internal Revenue Service (IRS) based on the particular facts and circumstances of the case. The current interest rates specified by the IRS (in Notice 2006-66, published in the Internal Revenue Bulletin 2006-30 on Jul. 24, 2006) are “4.83%” with a “90% to 105% permissible range” of “4.35 to 5.07”%, and a “90% to 110% permissible range” of “4.35 to 5.31”%. Therefore I have used a 6% rate in defining the “Preference Right” of the “Preferred Class” in the following examples.

### EXAMPLE #1

IF the “Preference Right” of the “Preferred Class” is to receive a Six Percent (6%) “dividend” (or allocation of “distributable earnings and profits”) per annum, and the LLC's overall ROI is 12% (“before tax” and 10.2% “after tax” to the UBIT TAXABLE, LLC, as illustrated in DIAGRAM #2) and the capital structure is Eighty Percent (80%) “Preferred Class” and Twenty Percent (20%) “Common Class”, the $10.20 of “distributable earnings and profits” (i.e., 12% ROI−15% tax×100% of “total capital” invested in the LLC=10.2%) would be allocated $4.80 to the “Preferred Class” (i.e., 6% “Preference Right”×80% of “total capital” invested in the “Preferred Class”=4.8%=$4.80) and the $5.40 balance of “distributable earnings and profits” would be allocable to the “Common Class” (i.e., $5.40 divided by 20% of “total capital” of the “Common Class”=27% Return on Investment (ROI) to the “Common Class”), thus illustrating the “positive leverage” in favor of the “Common Class” when the overall rate of return during a period exceeds the “Preference Right” of the “Preferred Class”.

### EXAMPLE #2

IF the “Preference Right” of the “Preferred Class” and the capital structure is the same as in Example #1, but the LLC's overall ROI is only 5% (“after tax” for the UBIT TAXABLE, LLC), then the $5.00 of the “distributable earnings and profits” would be allocated $4.80 to the “Preferred Class” (i.e., 6% “Preference Right”×80% of “total capital” invested in the “Preferred Class”=4.8%=$4.80) and only the remaining $0.20 balance of “distributable earnings and profits” would be allocated to the “Common Class” (i.e., $0.20 divided by 20% of “total capital” of the “Common Class”=1% ROI to the “Common Class”), illustrating the “negative leverage” that works against the “Common Class” when the overall rate of return during a period is less than the “Preference Right” of the “Preferred Class”.

Since the “Preferred Class” and the “Common Class” of “equity interest holders” are both classified as “equity ownership” for tax purposes (as distinguished from “debt”), there is no “debt financing” in the capital structure of the LLCs in Example #1 and Example #2 above, such as would cause any of the “distributable earnings and profits” to be reclassified under 26 USC 512(b)(4) as “subject to” the UBIT, when they would otherwise be “exempt from” the UBIT.

Therefore, there can be substantial “leverage” achieved in favor of “tax exempt” accounts, such as ROTH IRAs, when there are also funds available to be invested from Traditional IRAs and other “tax deferred” accounts to make “equity investments” in the UBIT TAXABLE, LLC and the UBIT EXEMPT, LLC.

Note that “debt financing” cannot be used in the UBIT TAXABLE, LLC without causing all UBIT Exempt income, gains or profits to become “subject to” UBIT (including income, gains and profits that would otherwise be “exempt from” UBIT), because the “debt financing” in the UBIT TAXABLE, LLC will be “attributable” to the “equity investment” by the UBIT TAXABLE, LLC in the SEGREGATED SERIES, LLC (under the Dept of Labor Regs. in 29 CFR 2510.3-101), causing all income, gains and profits in the SEGREGATED SERIES, LLC to become disqualified from treatment as “exempt from” UBIT by virtue of 26 USC 512(b)(4).

And, for the same reason, “debt financing” also cannot be used in the UBIT EXEMPT, LLC and/or in the SEGREGATED SERIES, LLC without causing income, gains and profits received by the UBIT EXEMPT, LLC and/or the SEGREGATED SERIES, LLC to become “subject to” the UBIT, by virtue of the limitation in 26 USC 512(b)(4).

### EXAMPLE #3

A highly “leveraged” (90/10) capital structure for the UBIT EXEMPT, LLC, the UBIT TAXABLE, LLC, and the SEGREGATED SERIES, LLC, is illustrated (as in DIAGRAM #3) as follows:

A UBIT EXEMPT, LLC capitalized with $45,900 from a Traditional IRA (representing 51% or more of the Equity Capital invested in the “Preferred Class”) and $44,100 (representing 49% of the “Preferred Class” Equity Capital) from another source (which may be from one or more “Disqualified Persons” as defined in 26 USC 4975, as long as the total “equity ownership” of all “Disqualified Persons” does not amount to 50% or more of the total “equity ownership” of the “Preferred Class” in the UBIT EXEMPT, LLC, in compliance with 26 USC 4975) and $5,100 of Equity Capital from a ROTH IRA (representing 51% of the total “Common Class” of Equity Capital) and $4,900 (representing 49% of the total “Common Class” of Equity Capital) from another source (which may be from one or more “Disqualified Persons” as defined in 26 USC 4975, as long as the total “equity ownership” of all “Disqualified Persons” does not amount to 50% or more of the total “equity ownership” of the “Common Class” in the UBIT EXEMPT, LLC, in compliance with 26 USC 4975), providing a Total Equity Capital of $100,000 (i.e., 90% “Preferred Class” and 10% “Common Class”) available for investment by the UBIT EXEMPT, LLC. This $100,000 of available Equity Capital is then invested (all or part) into the SEGREGATED SERIES, LLC, in exchange for a “Securities Certificate” (or other document acknowledging the investment) from the SEGREGATED SERIES, LLC representing 100% ownership of the UBIT Exempt Series.

A UBIT TAXABLE, LLC is also capitalized with $45,900 from a Traditional IRA (representing 51% or more of the Equity Capital invested in the “Preferred Class”) and $44,100 (representing 49% of the “Preferred Class” Equity Capital) from another source (which may be from one or more “Disqualified Persons” as defined in 26 USC 4975, as long as the total “equity ownership” of all “Disqualified Persons” does not amount to 50% or more of the total “equity ownership” of the “Preferred Class” in the UBIT TAXABLE, LLC, in compliance with 26 USC 4975) and $5,100 of Equity Capital from a ROTH IRA (representing 51% of the total “Common Class” of Equity Capital) and $4,900 (representing 49% of the total “Common Class” of Equity Capital) from another source (which may be from one or more “Disqualified Persons” as defined in 26 USC 4975, as long as the total “equity ownership” of all “Disqualified Persons” does not amount to 50% or more of the total “equity ownership” of the “Common Class” in the UBIT TAXABLE, LLC, in compliance with 26 USC 4975), providing a total Equity Capital of $100,000 (i.e., 90% “Preferred Class” and 10% “Common Class”) available for investment by the UBIT TAXABLE, LLC. This $100,000 of Equity Capital is then invested (all or part) into the SEGREGATED SERIES, LLC, in exchange for a “Securities Certificate” (or other document acknowledging the investment) from the SEGREGATED SERIES, LLC representing 100% ownership of the UBIT Taxable Series.

Assuming, for purposes of this Example #3, that ALL of the “capital” available for investment by the UBIT TAXABLE, LLC and the UBIT EXEMPT, LLC is invested into the SEGREGATED SERIES, LLC, the SEGREGATED SERIES, LLC would then have $200,000 available for investment.

Assuming, for purposes of this Example #3, that the SEGREGATED SERIES, LLC produces an overall rate of return of 12% on the investment of its $200,000 of available “capital” during the applicable period, and that the “character” of the income, gains and profits produced causes the allocation to be equal (50/50) between the UBIT Exempt Series and the UBIT Taxable Series, each “Segregated Series” will be allocated One-Half (½) of the 12% Return on Investment (ROI) or $12,000 ($200,000×12% ROI=$24,000×½=$12,000), which is then re-allocated and/or distributed by the UBIT Exempt Series to the UBIT EXEMPT, LLC., and by the UBIT Taxable Series to the UBIT TAXABLE, LLC.

When the UBIT EXEMPT, LLC receives the $12,000 allocation, the UBIT EXEMPT, LLC, then re-allocates/distributes the $12,000 received in the preceding paragraph (less expenses, if any, which are disregarded in this Example), between the “Preferred Class” and the “Common Class” as follows:

$5,400 will be allocable to the “Preferred Class” in the UBIT EXEMPT, LLC (representing the 6% assumed “Preference Right” on the $90,000 invested in the “Preferred Class” in this Example #3), and the remaining $6,600 will be allocable to the “Common Class” in the UBIT EXEMPT, LLC (representing the $12,000 available for distribution, less the $5,400 “Preference Right” of the “Preferred Class”) which represents a 66% ROI to the “Common Class” (i.e., $6,600 divided by the $10,000 invested in the “Common Class”=66% ROI) of the UBIT EXEMPT, LLC.

When the UBIT TAXABLE, LLC receives the $12,000 allocated/distributed to it from the UBIT Taxable Series in this Example #3 (assuming no other “expenses”), it will pay tax at the Corporate Income Tax Rate (at the tax rate specified in 26 USC 11), calculated in this Example as $1,800 (15% tax rate×$12,000) and the amount remaining “after tax” (i.e., $10,200) will then be allocable between the “Preferred Class” and the “Common Class” by first satisfying the “Preference Right” of the “Preferred Class” (6% assumed “Preference Right”×$90,000 invested in the “Preferred Class”=$5,400) and allocating the remaining balance “after tax” as “dividends” (exempt from UBIT under 26 USC 512(b)(1) as long as not “debt financed”) to the “Common Class” ($10,200 remaining “after tax”, less $5,400 allocable to the “Preferred Class”=$4,800 available for allocation to the “Common Class”), indicating a 48% ROI to the “Common Class” (i.e., $4,800 divided by the $10,000 invested in the “Common Class” in this Example #3=48% ROI).

Since this Example #3 assumes equal investments into the “Preferred Class” of the UBIT TAXABLE, LLC and the UBIT EXEMPT, LLC, the overall Return on Investment (ROI) to the investors in the “Preferred Class” will be equal to the “preferred return” allocable to the “Preferred Class” (i.e., 6% in this Example #3), and the Return on Investment to the investors in the “Common Class”, will be the total amount allocable to the “Common Class” investors ($6,600 from the UBIT EXEMPT, LLC plus $4,800 from the UBIT TAXABLE, LLC=$11,400 total ROI) divided by the $20,000 total “capital investment” in the “Common Class”, for an overall 57% ROI to the “Common Class” investors, as a result of thepositive leverage in favor of the “Common Class”.

Note that ROTH IRA(s) will benefit most from the positive leverage if they are the only investor(s) in the “Common Class”, and will benefit less if Traditional IRAs or other Entities or Accounts are also investors in the “Common Class” of interests in the UBIT EXEMPT, LLC and/or the UBIT TAXABLE, LLC, since the larger the “Common Class” becomes, the less of the ROI that is “focused” by the “Preferred/Common” Capital Structure on the ROTH IRA(s).

In this Example #3, we assumed that ROTH IRA(s) (and other Retirement and Pension Accounts) hold 51% or more in both, the “Common Class” and the “Preferred Class” of interests, in the UBIT EXEMPT, LLC and the UBIT TAXABLE, LLC, and ALL members of the “Disqualified Persons” group (“collectively” as defined in 26 USC 4975) hold 49% or less, of the “equity interests” in the “Preferred Class” and/or the “Common Class”, since IRAs (and other Pension and Retirement Accounts) are prohibited by 26 USC 4975 from “investing” in any entity (partnership, corporation, LLC, trust, investment pool, or other entity) which is “50% or more” owned by members of the “Disqualified Persons” Group. The inclusion of the “Disqualified Persons” as owners of 49% of the “Common Class” of Equity Capital causes 49% of the “after tax” “dividends” distributed by the UBIT TAXABLE, LLC, and 49% of the “distributions” from the UBIT EXEMPT, LLC, to be allocated/distributed to the “Disqualified Persons”, which are not “tax exempt” entities, and are therefore “taxable” on all of the amounts allocated/distributed to them under the normal Income Tax rules, even though the same amounts would have been free from all income tax if distributed to “tax exempt” or “tax deferred” Entities or Accounts.

### EXAMPLE #4

Same as the preceding Example #3, except that the ROTH IRA(s) are the sole investors in the “Common Class” of the UBIT EXEMPT, LLC and the UBIT TAXABLE, LLC, and invest only $1,000 from one or more ROTH IRA(s) in exchange for 100% of the “Common Class” of Equity Capital in the UBIT EXEMPT, LLC and the UBIT TAXABLE, LLC. The ROTH IRA(s) may also invest in the “Preferred Class”, together with other Pension and Retirement Accounts, and we assume for purposes of this Example #4 that the total “capital investment” into the “Preferred Class” is $99,000 (as illustrated in DIAGRAM #4).

Since the “Preferred Class” of interests totals $99,000 in each LLC (i.e., the UBIT EXEMPT, LLC and the UBIT TAXABLE, LLC), and the ROTH IRA(s) invested only $1,000 in the “Common Class” of the UBIT EXEMPT, LLC and only $1,000 in the “Common Class” of the UBIT TAXABLE, LLC, the total available for investment (assuming all funds are then invested in the SEGREGATED SERIES, LLC) would be $200,000.

Assuming the same 12% Return on Investment (ROI) as in Example #3, and the same “Preference Right” to the “Preferred Class” of the UBIT EXEMPT, LLC and the UBIT TAXABLE, LLC, and the same 50/50 allocation of the ROI between the UBIT EXEMPT, LLC and the UBIT TAXABLE, LLC as in Example #3, the following results occur:

The total investment earnings over the applicable period in the SEGREGATED SERIES, LLC is $24,000 ($200,000 capital invested×12% ROI=$24,000) which is allocated equally (50/50) between the UBIT Exempt Series and the UBIT Taxable Series (i.e., $24,000×50%=$12,000 to each Segregated Series).

The UBIT Exempt Series then re-allocates/distributes the $12,000 to the UBIT EXEMPT, LLC, which (assuming no other expenses) then allocates sufficient funds to satisfy the 6% “Preference Right” of the “Preferred Class” (i.e., 6% ×$99,000 “Preferred Class” investment=$5,940), and distributes the remainder ($12,000 less the $5,940 “Preference Right” of the “Preferred Class”=$6,060) to the “Common Class”. Thus, the “Common Class” receives a return of $6,060 on the $1,000 invested by the ROTH IRA(s) in the “Common Class”, for a 606% ROI to the “Common Class” in the UBIT EXEMPT, LLC.

Similarly, the UBIT Taxable Series re-allocates/distributes the $12,000 received by it to the UBIT TAXABLE, LLC, which (assuming no other expenses) then pays US Federal Income Tax at the applicable Corporate Tax Rate (i.e., 15% tax rate×$12,000 received in UBIT Taxable Income=$1,800 Corporate Income Tax), and then allocates/distributes $5,940 in (UBIT exempt) “after tax” dividends to satisfy the “Preference Right” of the “Preferred Class” (i.e., 6% “Preference Right”×the $99,000 invested in the “Preferred Class” of the UBIT TAXABLE, LLC=$5,940), and distributes the $4,260 remaining (i.e., $12,000 received −$1,800 tax −$5,940 “Preference Right”=$4,260 remainder) as (UBIT exempt) “after tax” dividends to the “Common Class” for a 426% ROI to the ROTH IRA(s) on the $1,000 invested in the “Common Class” of the UBIT TAXABLE, LLC.

Thus, on a consolidated basis, the ROTH IRA(s) would receive, in this Example #4, $6,060 ROI on the $1,000 invested in the “Common Class” of the UBIT EXEMPT, LLC, and an additional $4,260 ROI on the $1,000 invested in the “Common Class” of the UBIT TAXABLE, LLC, for a combined total of $10,320 ROI on the $2,000 invested in “Common Class” of both LLCs, which represents a 516% ROI to the ROTH IRAs, on a consolidated basis, over the applicable period, as illustrated in this Example #4.

Although we have assumed (in the preceding Examples) that the income, gains and profits earned by the SEGREGATED SERIES, LLC over the applicable period are allocated or allocable equally (50/50) to the UBIT EXEMPT, LLC and the UBIT TAXABLE, LLC, the actual allocation depends on the “character” of the “investment profits” (i.e., whether “subject to” UBIT or “exempt from” UBIT) and whether any “debt financing” is used to leverage the investments made (causing the “debt financed” profits to become “subject to” UBIT). Therefore, in any real world application, the allocation may vary from as much as 100% of the ROI “subject to” UBIT and 0% of the ROI “exempt from” UBIT, to as much as 100% “exempt from” UBIT and 0% “subject to” UBIT.

EXAMPLE #5

Same as the preceding Example #4, except that the “investments” selected by the Investment Manager of the SEGREGATED SERIES, LLC produce income, gains and profits which are 90% “subject to” UBIT, and only 10% “exempt from” UBIT.

Assuming the same total ROI as in Example #4, the $24,000 of ROI to the SEGREGATED SERIES, LLC is therefore allocable 90% (i.e., 90% ×$24,000=$21,600) to the UBIT Taxable Series, and 10% (i.e., 10% ×$24,000=$2,400) to the UBIT Exempt Series.

The UBIT Taxable Series then re-allocates/distributes the $21,600 allocated to it to the UBIT TAXABLE, LLC which (absent other expenses) would then pay Income Tax at the Corporate Tax Rate (15% Tax Rate in this Example ×$21,600 taxable=$3,240 Income Tax), and then re-allocate/distribute the required amount as “after tax” dividends to satisfy the “Preference Right” of the “Preferred Class” (i.e., 6% “Preference Right”×$99,000 invested in the “Preferred Class”=$5,940) and re-allocate/distribute the $12,420 remaining (i.e., $21,600 received by the UBIT TAXABLE, LLC −$3,240 Income Tax −$5,940 allocable to the “Preference Right” of the “Preferred Class”=$12,420 remainder) as “after tax” dividends to the “Common Class”, for a 1,242% ROI to the ROTH IRA(s) on the $1,000 investment in the “Common Class” of the UBIT TAXABLE, LLC.

The UBIT Exempt Series then reallocates/distributes the $2,400 allocable to it (i.e., 10% ×dthe $24,000 of total ROI allocated to the SEGREGATED SERIES, LLC=$2,400) to the UBIT EXEMPT, LLC which (assuming no other expenses) then allocates the available funds to satisfy the “Preference Right” of the “Preferred Class” (i.e., 6% “Preference Right”×$99,000 invested in the “Preferred Class”=$5,940) to the extent possible. In this Example the “earnings and profits” are insufficient to meet the “Preference Right” of the “Preferred Class” in the UBIT EXEMPT, LLC, in the applicable period, since the “Preference Right” is $5,940 and there is only $2,400 available to be applied toward the “Preference Right”. And, there are no “earnings and profits” remaining to be allocated to the “Common Class”, since the “earnings and profits” during the applicable period are insufficient to satisfy the “Preference Right” of the “Preferred Class”. Whether the “Preferred Class” will be entitled to receive the $3,540 “deficiency” (i.e., $5,940 “Preference Right”−$2,400 allocated to the “Preferred Class”=$3,540 “deficiency”) in the future, depends entirely on whether the “Preference Rights” of the “Preferred Class” are “cumulative” (i.e., “carry-forward” from years when there is a “deficiency” of “earnings and profits” to satisfy the “Preference Right”, to future years when there may be additional “earnings and profits” remaining after the “Preference Right” of the “Preferred Class” is satisfied for the current year, which may then be applied to “cure” a “deficiency” in a prior year) or “non-cumulative” (i.e., no “carry-forward” of “deficiencies” to future years).

### EXAMPLE #6

Continuing from Example #5 to the next succeeding period with the same total profits, but a different allocation by the SEGREGATED SERIES, LLC, assuming that the $24,000 ROI earned in the next succeeding period is allocable 40% (i.e., 40% ×$24,000=$9,600) to the UBIT Taxable Series, and 60% (i.e., 60% ×$24,000=$14,400) to the UBIT Exempt Series.

The $9,600 amount allocated to the UBIT Taxable Series would then be allocated/distributed to the UBIT TAXABLE, LLC which would (assuming no other expenses) then pay Income Tax at the Corporate Tax Rate (i.e., 15% Tax Rate in this Example×$9,600 taxable=$1,440 Income Tax), and then re-allocate/distribute the amount required to satisfy the “Preference Right” of the “Preferred Class” (i.e., 6% “Preference Right”×$99,000 invested in the “Preferred Class”=$5,940) as “after tax” dividends for the “current year”, and then re-allocate/distribute the remainder (i.e., $9,600 received by the UBIT TAXABLE, LLC −$1,440 Income Tax −$5,940 allocable to the “Preference Right” of the “Preferred Class”=$2,220 remainder) as “after-tax” dividends to the “Common Class”, for a 222% ROI to the ROTH IRA(s) on the $1,000 investment in the “Common Class” of the UBIT TAXABLE, LLC during the applicable period.

The $14,400 allocated to the UBIT Exempt Series (i.e., 60%×the $24,000 of total ROI to the SEGREGATED SERIES, LLC=$14,400) would then be re-allocated/distributed to the UBIT EXEMPT, LLC which would (assuming no other expenses) then allocate a sufficient amount to satisfy the “Preference Right” of the “Preferred Class” (i.e., 6% “Preference Right”×$99,000 invested in the “Preferred Class”=$5,940) for the current year.

And, IF the “Preference Right” of the “Preferred Class” is “cumulative” (i.e., “carries-forward” to succeeding years if not satisfied in a prior year), then an additional $3,540 would be allocated to “satisfy” the “deficiency” “carried-forward” from the prior year (in Example #5), leaving a remainder for allocation to the “Common Class” of $4,920 (i.e., $14,400 received from the SEGREGATED SERIES, LLC−$5,940 “Preference Right” of the “Preferred Class” in the current year, and−$3,540 “deficiency” “carried-forward” from the prior year=$4,920), for a 492% ROI to the ROTH IRA(s) on the $1,000 investment in the “Common Class” of the UBIT EXEMPT, LLC during the applicable period.

IF, in the preceding paragraph, the annual “Preference Right” of the “Preferred Class” was “non-cumulative” (i.e., no “carry-forward” of “deficiencies” to future years), the amount allocable to the “Common Class” would have been $8,460 (i.e., $3,540 more than the $4,920 allocable to the “Common Class” in the preceding paragraph), for a 846% ROI to the ROTH IRA(s) on the $1,000 investment in the “Common Class” of the UBIT EXEMPT, LLC during the applicable period.

Note that it is generally desirable for the ROTH IRA(s), which invest in the “Common Class” to also make a small investment in the “Preferred Class”, in order to permit “distributions” to the ROTH IRA(s) to be “reinvested” in the “Preferred Class” instead of accumulating gains in the “Common Class”, which causes the “Preferred Class” to increase due to “re-invested distributions” over time, while keeping the “Common Class” as a small percentage of the overall Equity Capital of each of the Intermediate Entities (i.e., the UBIT TAXABLE, LLC, and the UBIT EXEMPT, LLC).

Amounts “distributed” to the ROTH IRA(s) from the “Common Class” can then be reinvested into the “account(s)” established for the ROTH IRA(s) in the “Preferred Class”. Such reinvestment prevents the “Common Class” from accumulating a large amount of “undistributed” retained earnings and profits, which could be re-allocated to the “Preferred Class” upon liquidation of the UBIT TAXABLE, LLC and/or the UBIT EXEMPT, LLC, to satisfy the “Priority Right” of the “Preferred Class” to “return of capital” prior to any liquidating distribution to the “Common Class”, if such a “Priority Right” upon liquidation is granted to the “Preferred Class” by the person drafting the documents for the structure.

Although it is a matter of preference and discretion to the person who is designing the details of the structure described herein, it is my personal preference to grant to the “Preferred Class” a “Preference Right” to a “fixed percentage return” on the amount invested in the “Preferred Class” which is equal to or greater than the “weighted average interest rate” specified by IRS under 26 USC 412(b)(5)(B) and 412(l)(7)(C)(i) (the IRS “specified rate”), applicable at the time the LLCs are organized and funded, which IRS specified rate is “used to calculate the current liability for purposes of determining the full funding limitation under §412(c)(7) and the required contribution under 412(1)”, since a “Preference Right” which meets or exceeds these requirements appears less likely to be challenged by the IRS as “inadequate” or “artificial” or “imprudent” or “discriminatory” for investment by IRA and/or other Pension Accounts.

Although it is a matter of preference and discretion to the person who is designing the details of the structure described herein, it is my personal preference to “grant” the right to the “Preferred Class” that their annual “Preference Right” be “cumulative” in order to permit the “Preferred Class” to “make-up” “short falls” that are likely to occur from time to time over the investment life of the structure described herein, since that helps to justify the investment into the “Preferred Class” against challenges by the IRS as “inadequate” or “artificial” or “imprudent” or “discriminatory” for investment by IRA and/or other Pension Accounts.

Although it is a matter of preference and discretion to the person who is designing the details of the structure described herein, it is my personal preference to also “grant” a “Priority Right” to the “Preferred Class” to receive an amount upon liquidation of the Intermediate Entities that is equal to the amount invested in the “Preferred Class”, since that further helps to justify the investment against challenges by the IRS as “inadequate” or “artificial” or “imprudent” or “discriminatory” for investment by IRA and/or other Pension Accounts.

Although “debt financing” is not permitted in either of the Intermediate Entites (i.e., the UBIT TAXABLE, LLC and/or the UBIT EXEMPT, LLC) or in the SEGREGATED SERIES, LLC, (because of the “attribution” pursuant to the Dept. of Labor Regs. in 29 CFR 2510.3-101) in order to avoid causing ALL of the investments made by the SEGREGATED SERIES, LLC to be treated as “debt financed”, and therefore “subject to” the UBIT (even when they would otherwise be “exempt from” the UBIT), it is possible to utilize “debt financing” to leverage the returns to the SEGREGATED SERIES, LLC, by making “equity” investments from the SEGREGATED SERIES, LLC into one or more other entities (a “Subsidiary Entity”) which use “debt financing” to increase the Return on Investment (ROI) in the Subsidiary Entity. The “debt financing” in the Subsidiary Entity and the equity investment” by the SEGREGATED SERIES, LLC may be structured in such a way as to cause the income realized by the SEGREGATED SERIES, LLC to be treated as “subject to” the UBIT (as illustrated in Example #7, below), or in such a way as to cause the income to be treated as “exempt from” the UBIT (as illustrated in Example #8, below).

### EXAMPLE #7

Same as Example #4, except that the Investment Manager of the SEGREGATED SERIES, LLC elects to establish another LLC (the “SUBSIDIARY DEBT-FINANCED, LLC”), and makes an “Equity Investment” of $20,000 into the SUBSIDIARY DEBT-FINANCED, LLC, and invests the $180,000 balance available for investment (i.e., $200,000−$20,000=$180,000 remaining in the SEGREGATED SERIES, LLC) into “interest bearing” notes, which earn an assumed average of 12% over the applicable period (as illustrated in DIAGRAM #5).

The SUBSIDIARY DEBT-FINANCED, LLC, then obtains “debt financing” sufficient to pay for the purchase of a parcel of real property and the anticipated expenses for “remodeling” and “rehabilitation” of the real property (the “targeted property”). Upon the re-sale of the real property after completion of the “remodeling” and “rehabilitation”, the SUBSIDIARY DEBT-FINANCED, LLC, realizes a net profit of $100,000 (a round number for illustration purposes), in addition to receiving the $20,000 initially invested as “return of capital” (which is not taxable under the normal Income Tax rules), which it allocates/distributes to the SEGREGATED SERIES, LLC.

Since the acquisition of the real property is “debt financed” in this Example #7, the $100,000 of net profit realized by the SEGREGATED SERIES, LLC, from its investment in the SUBSIDIARY DEBT-FINANCED, LLC, is all “subject to” the UBIT, and will be “allocated” to the UBIT Taxable Series in the SEGREGATED SERIES, LLC, and then re-allocated/distributed to the UBIT TAXABLE, LLC. Assuming no other expenses, the UBIT TAXABLE, LLC will then pay Income Tax at the corporate tax rates (i.e., 15% on the first $50,000 of taxable income, 25% on the next $25,000 of taxable income, and 34% on that portion of the taxable income that exceeds $75,000) for a total tax of $22,250, leaving $77,750 available “after tax” for distribution to the “Preferred Class” and to the “Common Class” in the UBIT TAXABLE, LLC. Of the $77,750 of “earnings and profits” remaining “after tax”, $5,940 is allocable to the “Preferred Class” to satisfy its 6% “Preference Right” and the remaining $71,810 is allocable to the “Common Class”, for a 7,181% ROI to the ROTH IRA(s) on the $1,000 invested in the “Common Class” of interests in the UBIT TAXABLE, LLC.

In addition, the investment of the remaining $180,000 of investable funds in the SEGREGATED SERIES, LLC yielded an assumed 12% ROI, which was entirely “interest”, “exempt from” the UBIT as long as not “debt financed”. This $21,600 of “interest” income (i.e., 12%×$180,000=$21,600) is allocable to the UBIT Exempt Series in the SEGREGATED SERIES, LLC, and then re-allocated/distributed to the UBIT EXEMPT, LLC, which allocates/distributes $5,940 to the “Preferred Class” to satisfy the “Preference Right” of the “Preferred Class” of investors, with the remaining $15,660 (i.e., $21,600−$5,940=$15,660) then allocated/distributed to the “Common Class”, for a 1,566% ROI to the ROTH IRA(s) on the $1,000 invested in the “Common Class” of interests in the UBIT EXEMPT, LLC.

Note that the combined ROI to the ROTH IRAs from the UBIT TAXABLE, LLC (i.e., $71,810), and the UBIT EXEMPT, LLC (i.e., $15,660), amounts to a consolidated 4,373.5% ROI to the ROTH IRAs on their $2,000 capital investment in the “Common Class” of the two (2) Intermediate Entities.

As illustrated in the Example #7, the effective use of “debt financing” can substantially increase the yields to the ROTH IRA(s), and is therefore appropriate to consider when the investment opportunity is such that “positive leverage” can be obtained, which increases the ROI substantially above the ROI that can be produced without “debt financing”.

However, even greater leverage can be obtained if the “debt financing” is structured so that it does not taint the “income” allocable to the SEGREGATED SERIES, LLC, as illustrated in the following Example #8.

### EXAMPLE #8

Essentially the same investment as in Example #7, except that instead of using a SUBSIDIARY DEBT-FINANCED, LLC, the SEGREGATED SERIES, LLC purchases an “out-of-the-money” “Option to Purchase” the targeted property from the Seller (who is not a “disqualified person” within the meaning of 26 USC 4975(e)(2), in relation to the transaction), while the IRA Beneficiary simultaneously (in the same closing and from the same Seller) purchases the targeted property “subject to” the “out-of-the-money” “Option to Purchase” issued in the closing to the SEGREGATED SERIES, LLC (as illustrated in DIAGRAM #7).

(Note that an “out-of-the-money” “Option to Purchase” represents the “right to buy” at a price that is above the current “fair market value” (i.e., the “right” to “pay too much” for the property). In contrast, an “in-the-money” “Option to Purchase” represents the “right to buy” at a price that is less than the current “fair market value”. Thus, an “in-the-money” Option has an “intrinsic value” (equal to the amount that the Option purchase price is less than the current “fair-market value”), and an “out-of-the-money” Option has no “intrinsic value”, since the Option purchase price is above the current “fair market value”. Since, the “right” to “pay too much” is not a very valuable “right” an “out-of-the-money” Option has relatively little value, as compared with an “in-the-money” Option. Therefore, an “out-of-the-money” Option can be purchased for a very small sum, typically $1,000 or less, which makes the Option strategy very attractive for investing ROTH IRA funds, as illustrated in this Example #8.)

The IRA Beneficiary, who acquires the real property “subject to” the “out-of-the-money” Option issued to the SEGREGATED SERIES, LLC (from the same Seller and in the same closing), may use any amount of “debt financing” he/she deems appropriate, which “debt financing” is not attributable to the SEGREGATED SERIES, LLC under 26 USC 4975, and does not cause the acquisition of the “out-of-the-money” “Option to Purchase” by the SEGREGATED SERIES, LLC to be treated as “debt financed” for purposes of the UBIT (26 USC 511-514), as long as there is no “pledge” or use as “security” or “collateral” of any of the funds of the IRA Account(s) or of any of the Entities in which the IRA Account(s) are investors. (Note that the use of IRA funds as “collateral” or “security” is also a violation of the “prohibited transaction” rules in 26 USC 408 and 26 USC 4975, which would cause the “termination” of IRA status, and therefore must be strictly avoided.)

And, since the SEGREGATED SERIES, LLC acquires the “out-of-the-money” “Option to Purchase” for a small sum of money (e.g., $1,000 or less) from the Seller of the real property (who is not a “Disqualified Person”), and not from the IRA Beneficiary (or any other person in the “Disqualified Persons” group defined by 26 USC 4975(e)(2)-), the acquisition of the “out-of-the-money” “Option to Purchase” does not violate the “prohibited transaction” rules in 26 USC 4975 by causing a “transfer” of a “benefit” from the IRA to the IRA Beneficiary in connection with the transaction, which might arguably occur, if the IRA were to pay a larger amount for the Option (e.g., $20,000 for an “in-the-money” Option), since the IRA Beneficiary's “ability” to purchase of the real property might arguably have been “aided” by the larger investment from the IRA, but such argument does not apply when the amount invested by the IRA (directly or indirectly) is insufficient to have realistically “aided” the IRA Beneficiary's “ability” to purchase the property.

Assuming the acquisition of real property for $100,000 (a round number for illustrative purposes) by the IRA Beneficiary “subject to” the “out-of-the-money” “Option to Purchase” issued by the Seller of the real property to the SEGREGATED SERIES, LLC, and assuming the IRA Beneficiary estimates that the property will require approximately $30,000 of additional investment for “remodeling” and “rehabilitation”, it would be appropriate for the “out-of-the-money” “Option to Purchase” issued to the SEGREGATED SERIES, LLC to be for an amount equal to or greater than $130,000 (e.g., $140,000 as illustrated in DIAGRAM #7). The IRA Beneficiary “borrows” from various sources, which may include conventional lenders, Seller financing, and friends and other investors, the amount of $130,000, and plans to use his own efforts to complete the “remodeling” and “rehabilitation”.

Since the “right” to “pay too much” for the real property (i.e., the “right” to pay $140,000 for real property with a “fair market value” in an “arms length transaction” of only $100,000 between buyer and seller) is not a “very valuable” right, the SEGREGATED SERIES, LLC may pay only $1000 for the “out-of-the-money” “Option to Purchase” the real property for the “Option Price” of $140,000, that expires in 1 to 10 years, depending on the “exit strategy”. The balance of the funds available to the SEGREGATED SERIES, LLC may be invested in “interest bearing” Notes (issued by persons who are not part of the “Disqualified Persons” group) and yield an assumed average 12% per annum ROI, as in Example #7.

Following completion of the “remodeling” and “rehabilitation” of the real property, the real property is assumed to be successfully “resold” for $240,000. The SEGREGATED SERIES, LLC “delivers” its “Option to Purchase” to the closing escrow agent to be “extinguished” in the closing, without ever “exercising” the “Option to Purchase”, and the IRA Beneficiary delivers his “Deed” to the closing escrow agent, who completes the “resale” of the property and distributes the “profits” realized as follows:

The first $140,000 of “resale” proceeds (the amount “up to” the “Option Price”) is allocated to the IRA Beneficiary, who purchased the real property with “borrowed” money for $100,000 plus the additional “remodel” and “reinvestment” costs of $30,000, for a “profit” to the IRA Beneficiary of $10,000 ($140,000 of the “resale” proceeds−$100,000 purchase price and $30,000 remodel costs=$10,000 profit). This “profit” will be taxable to the IRA Beneficiary as “short-term” or “long-term” “capital gain” (or as “ordinary income” if the IRA Beneficiary is a “dealer” in real estate) under the normal Income Tax rules.

The amount of the “resale” proceeds which are in excess of the $140,000 “Option Price” are allocable to the “Option Holder” (i.e., to the SEGREGATED SERIES, LLC), upon the “extinguishment” “without exercise” of the “Option to Purchase” at the $140,000 “Option Price”.

Since the Option to Purchase is never exercised, the SEGREGATED SERIES, LLC does not “go into” “title” on the real property, and has merely “bought” and later “sold” an “Option to Purchase” a parcel of real property in a very similar manner to the way that Stock Options are “bought” and “sold” on stocks listed on the various Stock Exchanges, without such Options ever being “exercised”.

Therefore, the SEGREGATED SERIES, LLC will receive the $100,000 amount of the “resale” proceeds which exceeds the “Option Price” (i.e., “resale” price of $240,000−less “Option Price” of $140,000=$100,000 profit on the Option), as “Capital Gain” (which may be “long-term” or “short-term”) which is “exempt from” the UBIT, since there was no “debt financing” involved in the acquisition of the Option to Purchase in this Example.

The SEGREGATED SERIES, LLC allocates the “Capital Gain” (not “debt financed”) to the UBIT Exempt Series, for re-allocation/distribution to the UBIT EXEMPT, LLC, which allocates $5,940 to the satisfaction of the “Preference Right” of the “Preferred Class” of interests in the UBIT EXEMPT, LLC, and the remaining $94,060 to the “Common Class” of interests in the UBIT EXEMPT, LLC, for a 9,406% ROI to the ROTH IRA(s) on the $1,000 invested in the “Common Class” of the UBIT EXEMPT, LLC.

The $199,000 of funds remaining available to the SEGREGATED SERIES, LLC ($200,000−the $1,000 used to “purchase” the “Option to Purchase”) were also assumed to be invested to yield an average 12% per annum of “interest” income, which amounts to an additional $23,880 (i.e., $199,000×12%=$23,880) of “interest” income (not “debt financed”) which is also “exempt from” the UBIT, and is therefore allocable to the UBIT Exempt Series in the SEGREGATED SERIES, LLC, for re-allocation/distribution to the UBIT EXEMPT, LLC. Since the UBIT EXEMPT, LLC has already met the “Preference Right” of the “Preferred Class” of interests in the UBIT EXEMPT, LLC (above), the entire additional $23,880 of “interest” income is allocable to the “Common Class”, thus increasing the allocation to the “Common Class”, and thence to the ROTH IRA(s) in this Example, to $117,940 (i.e., $94,060+$23,880=$117,940), indicating a 11,794% ROI to the ROTH IRA(s) on the $1,000 invested in the “Common Class” of the UBIT EXEMPT, LLC.

Note, however, that since there was nothing to allocate to the UBIT Taxable Series in the SEGREGATED SERIES, LLC, and by the UBIT Taxable Series to the UBIT TAXABLE, LLC, that the “Preference Right” of the “Preferred Class” in the UBIT TAXABLE, LLC would not be satisfied in the current period, and would therefore either: [1] “carry-forward” to the next “investment period”, if the “Preference Right” is “cumulative”, or [2] be “extinguished” if “non-cumulative” (as discussed above).

Therefore, depending on the investment strategies adopted by the IRA Beneficiary, it may be or become advisable to consider minimizing amount invested in the UBIT TAXABLE, LLC, and investing the majority of the available funds through the UBIT EXEMPT, LLC, IF the strategies being used produce primarily “income” that is “exempt from” the UBIT. Or, in the reverse situation, to consider minimizing the amount invested in the UBIT EXEMPT, LLC, and invest the majority of the available funds through the UBIT TAXABLE, LLC, IF the strategies being used produce primarily “income” that is “subject to” the UBIT.

Or, IF the investment strategies consistently favor one of the Intermediate Entities and disregard the other, the UBIT EXEMPT, LLC or the UBIT TAXABLE, LLC (i.e., the one not being used) may be eliminated from the structure, or the “cumulative” feature of the “Preference Right” of the “Preferred Class” in the LLC which is not being used may be limited or eliminated.

Thus, for example (as illustrated in DIAGRAM #6) when the IRA Beneficiary or other Investment Manager is primarily trading Stock Options or other “highly leveraged” securities investment vehicles (e.g., “currencies”, “commodities”, “futures”, etc.), the UBIT TAXABLE, LLC, may be superfluous and unnecessary, as long as the “margin loan” available in the Margin Account (which Margin Account is a pre-requisite for trading “options”, “commodities”, “futures”, etc.) is never used, since the use of a “margin loan” in connection with a transaction will cause the profits, gains and income from that transaction to become “subject to” the UBIT, and therefore allocable/distributable to the UBIT Taxable Series and then to the IRA or other “tax deferred” or “tax exempt” Entity or Account (in the absence of the UBIT TAXABLE, LLC).

Any such adjustments, however, must be carefully considered before being implemented in order to consider the implications for the overall structure, in terms of whether any of the changes raise issues of “discrimination” against a Plan or Account and/or in favor of the IRA or Plan Beneficiary (prohibited by 26 USC 4975(c)(D)-), or are equivalent to a “contribution” to the IRA Account which is “other than cash” (prohibited by 26 USC 408(a)(1)-).

And finally, as illustrated in DIAGRAM #8, the Capital Structures of the Intermediate Entities (e.g., the UBIT TAXABLE, LLC, and the UBIT EXEMPT, LLC) are sufficiently flexible to permit the Investment Manager to effectively “control” the amount of “income” that is allocated/distributed to the members of the “Disqualified Persons” Group, by seven (7) simple steps, as follows:

[1] suspend ALL investment activities while completing steps [2] through [6];

[2] allocate and distribute the “profits, gains and income” earned to date to the UBIT Taxable Series, and to the UBIT Exempt Series, in the SEGREGATED SERIES, LLC, in accordance with the “tax attributes” of the earnings to date;

[3] allocate and distribute ALL “profits, gains and income” earned to date to the UBIT TAXABLE, LLC (from the UBIT Taxable Series), and to the UBIT EXEMPT, LLC (from the UBIT Exempt Series), respectively;

[4] allocate and distribute ALL of the “net earnings and profits” (i.e., the portion remaining “after tax”) to the “Preferred Class”, in accordance with their “Preference Rights”, and to the “Common Class”, as to the remainder; and

[5] withdraw an amount of “capital” from the Capital Account of the “Disqualified Person” in the “Common Class”, such that the percentage allocation is reduced to the desired level (leaving perhaps only $1.00 in the Capital Account of the “Disqualified Person” in the “Common Class” to keep the Capital Account available for later “re-investment” by the “Disqualified Person”);

[6] direct the IRA Custodian or Account Custodian or Trustee to “reinvest” all then available funds into the “Preferred Class” in the UBIT TAXABLE, LLC, and/or the UBIT EXEMPT, LLC (as appropriate for the investment strategy of the Investment Manager); and

[7] resume investment activities.

Note that, as illustrated in DIAGRAM #8, the “Disqualified Persons” Group may own up to 49% (i.e., but must always own “less than 50%”) of the Equity Capital in each “Class” (e.g., “Common” and “Preferred”) of Equity Capital in the Intermediate Entities (e.g., the UBIT TAXABLE, LLC, and the UBIT EXEMPT, LLC), and the “tax exempt” and/or “tax deferred” Entities and Accounts (the “Exempt Accounts”) may own 51% or more of the Equity Capital in each “Class” (e.g., “Preferred Class” and “Common Class”) of the Intermediate Entities, without violating the “prohibited transaction” rules of 26 USC 4975, since the “prohibited transaction” rules are not violated as long as the Exempt Accounts do not invest in or hold an “equity interest” in an partnership, corporation or other entity which is “owned” (at the time of “investment” or at any subsequent time while the Exempt Accounts hold an “equity interest” in the entity) “50% or more” by the members of the “Disqualified Persons” Group.

Therefore, at the beginning of a “tax year” (or other investment period), the Investment Manager (a “Disqualified Person” under 26 USC 4975) may chose to invest in the “Common Class” of “equity interests” in the Investment Entity at the maximum permitted level (e.g., 49%, but always “less than 50%”), causing approximately one-half (e.g., 49%) of the investment earnings, gains and profits to be allocated to the “Disqualified Person”.

However, at a later point in time during the tax year (or other investment period), the Investment Manager (who is a “Disqualified Person”) may decide that the amount of “investment profits” allocated to his/her personal Capital Account (or to the Capital Account of any other members of the “Disqualified Persons” Group, including any entities owned “directly or indirectly” by the members of the “Disqualified Persons” Group) has reached the maximum that he/she desires to be reported in his/her personal 1040 Income Tax return for the year, and therefore the Investment Manager may desire to cause “future profits” to be directed toward his/her ROTH IRA Account (or other “tax exempt” or “tax deferred” Entity or Account), which can receive the investment profits “exempt from” UBIT (under 26 USC 512(b)(5)-), as long as “debt financing” is/was not used to purchase or hold the investments (according to 26 USC 512(b)(4)-).

At that time, by the Investment Manager can take the seven (7) steps set out above at paragraph [0260], to suspend investment activities for a short time, distribute all “investment profits” earned to date, and then “reduce” the amount of the Capital Account of the “Disqualified Person(s)” (one or more, who the Investment Manager desires to receive a smaller allocation of “future profits”) in the “Common Class” to near zero (e.g., $1.00), before resuming further investment activities. And by taking those seven (7) steps, the Investment Manager causes the Investing Entity to allocate virtually all “future investment profits” to the ROTH IRA or other “tax exempt” or “tax deferred” Entity or Account, which then holds “virtually all” of the Equity Capital in the “Common Class” during the period after the “reduction” of the “capital investment” of the “Disqualified Persons”.

The “withdrawal” of Equity Capital, to “reduce” the percentage ownership of the “Common Class” by members of the “Disqualified Persons” Group, does not violate the “prohibited transaction” rules, since (1) the change is “prospective only” and does not shift any “existing benefit” between the “Disqualified Person” and the IRA Account, (2) the “withdrawal” of Equity Capital “reduces” the “percentage ownership” of the Equity Capital by the “Disqualified Persons” Group, and therefore does not cause the Equity Ownership of the “Disqualified Persons” Group to become at any time “50% of more”, in violation of the prohibition in 26 USC 4975.

At another time, such as at the beginning of a new Tax Year, the Investment Manager may go through the exact same process, except this time to “increase” (instead of “reduce”) the Capital Account(s) of the “Disqualified Person(s)” to the 49% level (i.e., must always be less than 50% in order to comply with the “prohibited transaction” rules of 26 USC 4975), in order to cause the “future investment profits” to be allocated 49% to the “Disqualified Persons” Group, and 51% to the “tax exempt” and/or “tax deferred” Entities and Accounts, until the “Disqualified Persons” have been allocated the amount of “investment profits” desired by the Investment Manager for the Tax Year (or other investment period).

As long as all “investment activities” are suspended while the seven (7) Steps described in paragraph [0260] are taken (whether to “increase” or “decrease” the Equity Capital Account of the “Disqualified Persons” Group in the entity), and the total Equity Capital of the “Disqualified Persons” Group never exceeds the maximum permitted (i.e., it never amounts to “50% or more” of the Total Equity Capital in any Class of Equity Capital in the entity), the “prohibited transaction” rule in 26 USC 4975(c)(1)(D) is not broken (because the Entity in which the “tax exempt” and/or “tax deferred” Entities or Accounts are investing, even if arguably a “Disqualified Person” as defined in 26 USC 4975 (e)(2), is protected by the “exception” in 26 USC 4975(d)(11), where the Entity is merely the “investment conduit”), and there is no shifting of a benefit between the Exempt Entity or Account and any “Disqualified Person”, within the meaning of 26 USC 4975(c)(1), since only “prospective future investment activities” are affected.

And then, at a later time, when the amount of “investment profits” allocated to the “Disqualified Persons” Group has reached the Investment Manager's “objective” for the Tax Year (or other period), the Investment Manager can again repeat the seven (7) steps set forth at paragraph

above, to again “reduce” the Equity Capital Account of the “Disqualified Persons” and thus prevent further allocation of (any significant) “future investment profits” to the “Disqualified Persons” Group, and thus maximize the accumulation of wealth in the ROTH IRAs and other Exempt Accounts free from all Income Tax (including UBIT).

1. A method, structure and system to “automatically segregate” for the Tax Reporting purposes of “tax exempt” and “tax deferred” Entities and Accounts: [a] income, gains and profits (i.e., “income”) with “tax attributes” which causes it to be “subject to” the Unrelated Business Income Tax (the “UBIT”) imposed by 26 USC 511-514; from [b] other income with “tax attributes” which permits it to be “exempt from” the UBIT, when received by a “tax exempt” or “tax deferred” Entity or Account.

2. The method of claim #1 wherein a Limited Liability Company is formed as a “statutory segregated series limited liability company” (to with: the “SEGREGATED SERIES, LLC”), with multiple (typically at least two) “separate” “segregated series” in compliance with the law of a jurisdiction which permits “segregated series” limited liability companies.

3. The condition of claim #1 wherein the SEGREGATED SERIES, LLC is formed with AT LEAST ONE “segregated series” which is designated or described as the “segregated series” to be allocated and/or to receive income which is “exempt from” the UBIT (to with: the “UBIT Exempt Series”).

4. The condition of claim #1 wherein the SEGREGATED SERIES, LLC is formed with AT LEAST ONE OTHER “segregated series” which is designated or described as the “segregated series” to be allocated and/or to receive the income which is “subject to” (i.e., taxable under) the UBIT (to with: the “UBIT Taxable Series”).

5. The optional method of claim #1 wherein funds may be invested into the SEGREGATED SERIES, LLC through one or more Intermediate Entity(ies) (e.g., a UBIT TAXABLE,LLC and a UBIT EXEMPT, LLC, which is owned in whole or in part by one or more IRAs (or other “tax exempt” or “tax deferred” Entities or Accounts), as Equity Capital of the SEGREGATED SERIES. LLC, and the units or interests issued to each Intermediate Entity by the SEGREGATED SERIES, LLC are designated to the UBIT Taxable Series and to the UBIT Exempt Series, respectively.

6. The limitation of claim #2 (described in ¶5) wherein income allocable to the UBIT Taxable Series is re-allocated/distributed exclusively to the UBIT TAXABLE, LLC (if the UBIT TAXABLE, LLC, is utilized as the Intermediate Entity as described in claim #5), and the income allocable to the UBIT Exempt Series is reallocated/distributed exclusively to the UBIT EXEMPT, LLC (if the UBIT EXEMPT, LLC, is utilized as the Intermediate Entity as described in ¶5).

7. The method of claim #2 (in ¶5) wherein the UBIT TAXABLE, LLC (if utilized as an Intermediate Entity) is taxed as a corporation (or elects to be taxed as “an association taxable as a corporation” by appropriate election on IRS form 8832) in order to pay the UBIT at the (currently more favorable) “Corporate Income Tax Rates” specified in 26 USC 11, after deduction of expenses and management fee, if any (instead of the currently less favorable “Trust Income Tax Rates” specified in 26 USC 1), on all income “subject to” the UBIT that is allocated/distributed to the UBIT TAXABLE, LLC, from the UBIT Taxable Series of the SEGREGATED SERIES, LLC.

8. The further illustration of the method of claim #2 (described in ¶6 and ¶7) wherein the balance of the funds remaining available “after tax” are then distributable/distributed by the UBIT TAXABLE, LLC (if the Intermediate Entity is utilized) to the IRA (or other “tax exempt” or “tax deferred” Entity or Account) and other owners of the UBIT TAXABLE, LLC, as “dividends” which are “exempt from” the UBIT Tax under 26 USC 512(b)(1) & (5).

9. The further illustration of claim #2 (described in ¶6 and ¶7) wherein the “income” allocable/distributed to the UBIT TAXABLE, LLC, would otherwise become “taxable” to the IRA (or other “tax exempt” or “tax deferred” Entity or Account) and other owners of interests in the UBIT Taxable Series (if the Intermediate Entity is NOT utilized as illustrated in ¶8), at the higher Individual or Trust Income Tax Rates specified in 26 USC 1.

10. The method of claim #1 wherein funds held for investment are invested in the name of the SEGREGATED SERIES, LLC, or Nominee therefore, without designation of “series”, and are therefore allocated to the UBIT Exempt Series or to the UBIT Taxable Series, respectively, in accordance with the “default allocation” specified in the Operating Agreement of the SEGREGATED SERIES, LLC.

11. The further illustration of the method of claim #1 (as further specified in ¶10) wherein the “default allocation” specified in the Operating Agreement of the SEGREGATED SERIES, LLC requires that income be allocated to the UBIT Taxable Series for reallocation/distribution to the UBIT TAXABLE, LLC (if an Intermediate Entity is utilized as illustrated in ¶5 and ¶6) or other owners of interests in the UBIT Taxable Series (if the Intermediate Entity is NOT utilized), when such income has the “tax attributes” which causes it to be “subject to” the UBIT.

12. The further illustration of the method of claim #1 (as further specified in ¶10) wherein the “default allocation” specified in the Operating Agreement of the SEGREGATED SERIES, LLC requires that income be allocated to the UBIT Exempt Series for reallocation/distribution to the UBIT EXEMPT, LLC (if an Intermediate Entity is used as the holder of the units or interests in the UBIT Exempt Series as illustrated in ¶5 and ¶6) or other owners of interests in the UBIT Exempt Series (if the Intermediate Entity is NOT utilized), when such income has the “tax attributes” which causes it to be “exempt from” the UBIT.

13. The method of claim #1 which permits one or more IRAs (or other “tax exempt” or “tax deferred” Entities or Accounts) and others to make investments into the Equity Capital of the SEGREGATED SERIES, LLC through one or more Intermediate Entity(ies), with the units or interests issued by the SEGREGATED SERIES, LLC to the investors (or to the Intermediate Entity(ies)) “specifically designated” to the UBIT Exempt Series to permit the UBIT EXEMPT, LLC, to receive from the UBIT Exempt Series only those allocations/distributions which are “exempt from” the UBIT, and “specifically designated” to the UBIT Taxable Series to permit the UBIT TAXABLE, LLC, to receive from the UBIT Taxable Series only those allocations/distributions which are “subject to” the UBIT.

14. The limitation of claim #1, and if applicable, claim #2 (when the investment described in ¶13 is made through an Intermediate Entity) which requires that the Equity Capital of the SEGREGATED SERIES, LLC, whether directly held, or indirectly held (though the ownership of the Equity Capital of an Intermediate Entity, considered jointly or separately), may not be “Fifty Percent (50%) or more” owned by persons who are members of the “Disqualified Persons” Group, as defined in 26 USC 4975(e)(2)&(6).

15. The limitation of claim #1, and if applicable, claim #2, which requires that the percentage ownership of the Equity Capital held by the ultimate owners of the Equity Capital of each Intermediate Entity (if the investment described in ¶13 is made through an Intermediate Entity), must be exactly the same proportional ownership in each and every Intermediate Entity, in order to eliminate any potential discrimination in favor of or against one or more of the ultimate owners of the Equity Capital, which could otherwise occur as a result of a “non-pro-rata” allocation between the UBIT Taxable Series and the UBIT Exempt Series, described in ¶12 and ¶13, caused by the “default allocation” formula specified in ¶10.

16. The optional alternative to claim #1, and to claim #2 (if the investment described in ¶13 is made through an Intermediate Entity), wherein an alternate legal form or entity (e.g., Trust or corporation or other entity) or Trustee, Nominee or other arrangement, is used as a substitute for the SEGREGATED SERIES, LLC described as to claim #1 or for the Intermediate Entity described as to claim #2, to achieve the same effect described in claim #1, and/or claim #2.

17. The potential preserved by claim #2 and ¶13 (if the investment described in ¶13 is made through an Intermediate Entity), to create a “Common Class” and a “Preferred Class” of units or interests in the Equity Capital of each of the Intermediate Entities (e.g., the “UBIT TAXABLE, LLC, and the UBIT EXEMPT, LLC), which is similar in rights to the “Common Stock” and the “Preferred Stock” in a corporate capital structure.

18. The permissive use of a “Common Class” and “Preferred Class”, as described in ¶17, to permit LARGE investments by Traditional IRAs (and other “tax deferred” and/or “tax exempt” Entities and Accounts) and others (subject to the limitations stated in ¶14 and ¶15) to be made into the “Preferred Class” of Equity Capital of each of the Intermediate Entities, and SMALL investments by ROTH IRAs and others (subject to the limitations stated in ¶14 and ¶15) in the “Common Class” of Equity Capital of each of the Intermediate Entities specified in ¶17.

19. The optional method described in ¶17 which permits the specification of a “Preference Right” in favor of the “Preferred Class” in the Intermediate Entity(ies) specified in ¶16 to receive a “specified amount” or “percentage” as the “return on investment” to investors in the “Preferred Class”, and subordinates the rights and interests of the “Common Class” to the “Preference Right” granted to the “Preferred Class” of units or interests in the Equity Capital of the Intermediate Entity(ies).

20. The optional method of ¶17 which permits the specification of a “Priority Right” to “return of capital” upon dissolution or liquidation of the Intermediate Entity(ies) specified in ¶17, in favor of the “Preferred Class”, and subordinates the rights and interests of the “Common Class” to the “Priority Right” granted to the “Preferred Class” of units or interests in the Equity Capital of the Intermediate Entity.

21. The method of ¶17 and ¶18 and ¶19 which permits “leverage” to be created in favor of the “Common Class” in the Intermediate Entity(ies) specified in ¶17, when the investment yields to the Intermediate Entity(ies) specified in ¶17 exceed the “Preference Right” allocable the “Preferred Class” specified pursuant to ¶19, but without the use of “debt financing” of a character that would cause investment profits to become “subject to” UBIT under 26 USC 512(b)(4), that would be “exempt from” UBIT in the absence of such “debt financing”.

22. The method of ¶17 and ¶18 and ¶19 which provides for the periodic “distribution” of all investment profits (in excess of the “Preference Right” of the “Preferred Class” specified pursuant to ¶19) to the “Common Class” investors, followed by the reinvestment of all of such “distributions” into the “Preferred Class” of units or interests in the Equity Capital of the Intermediate Entity(ies) (subject to the limitations stated in ¶14 and ¶15), in order to maintain the “Common Class” as the smaller class of Equity Capital in each Intermediate Entity.

23. The facility permitting periodic adjustments to be made (i.e., “increase” or “decrease”) in the amount invested by each investor in the “Preferred Class” and the “Common Class” of Equity Capital in the Intermediate Entity(ies) specified in ¶17 (subject to the limitations stated in ¶14 and ¶15), during a period that “investment activities” are suspended in the SEGREGATED SERIES, LLC, without causing a prohibited transaction under 26 USC 4975.

24. The facility pursuant to ¶23 to exercise some control as to the amount of “future” investment profits which will become allocable to a particular Equity Capital holder, based on the pro rata percentage of ownership of the entire “Common Class” of Equity Capital by such Equity Capital holder during the applicable period (subject to the limitations stated in ¶14 and ¶15).

25. The optional method of claim #1 which permits the optional use of “debt financing” to increase leverage by means of an equity investment by the SEGREGATED SERIES, LLC in a subsidiary (i.e., a SUBSIDIARY DEBT-FINANCED, LLC—which SUBSIDIARY DEBT-FINANCED, LLC then obtains the “debt financing”), in order to generate larger profits on an investment when advantageous (even though such profits are “subject to” UBIT, by virtue of the “debt financing”, due to the limitation of 26 USC 512(b)(4)-).
